(19) United States
(12) Patent Application Publication
(10) Pub. No.: US 2007/0285716 A1
(43) Pub. Date: Dec. 13, 2007

(54) OPTICAL WRITING CONTROLLER AND IMAGE FORMING APPARATUS

(76) Inventor: Satoshi Ohmiya, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/695,315

(22) Filed: Apr. 2, 2007

(30) Foreign Application Priority Data
Apr. 24, 2006 (JP) 2006-119876

(51) Int. Cl. G06K 15/02

(52) U.S. Cl. 358/1.16; 358/1.15; 358/515

(57) ABSTRACT

A write control IC includes a plurality of memories, a plurality of image processing units, a switch control unit, and a plurality of LD control units. The image processing units process image data. The memories store therein the image data. The switch control unit switches the memories to store the image data processed by the image processing units for each of the image processing units. The LD control units obtain the image data from each of the memories and controls LDs to write the image data.

### CROSS-REFERENCE TO RELATED APPLICATIONS

The present document incorporates by reference the entire contents of Japanese priority document, 2006-119876 filed in Japan on Apr. 24, 2006.

### BACKGROUND OF THE INVENTION

1. Field of the Invention

The present invention generally relates to an optical writing controller and an image forming apparatus. The present invention specifically relates to a technology for controlling data-write operation.

2. Description of the Related Art

A conventional image forming apparatus is configured to have one Integrated Circuit (IC) to control writing for each color. Therefore, a full-color image forming apparatus that forms images with four colors, black, yellow, cyan, and magenta (KYCM), is mounted with four identical write control ICs. An image forming apparatus that forms images with two colors, black and red, is mounted with two identical write control ICs.

Such an image forming apparatus uses different functions according to the color(s) with which an image is formed. On the other hand, to develop IC for write control, a large amount of development cost is required.

For this reason, a technology suggested in recent years is such that only one type of IC for write control including functions required for all colors is developed and this developed write control ICs are mounted on an image forming apparatus as many as image-forming colors. In this case, the write control ICs each mounted so as to perform a write process for an arbitrary image-forming color use only the functions required for performing a write process for a particular image-forming color.

For example, Japanese Patent Application Laid-Open No. 2005-178080 discloses a full-color image forming apparatus. This image forming apparatus includes a write control unit for each image-forming color to control a laser diode (LD) unit that forms an image. This write control unit includes a write image processing unit for developing and processing color-specific image data, an LD driver unit that controls an LD, and a synchronizing signal control unit for detecting a write start position in a main scanning direction.

However, there are many types of image forming apparatuses manufactured and available on the market with different numbers of image-forming colors, such as monochrome machines and full-color machines, and with different image forming speeds, such as high-speed machines and low-speed machines.

This is because there are various types of demands from users for image forming apparatuses. For example, frequent users demand machines with high productivity, whilst users desiring high-definition image quality demand machines with high resolution and high definition. In another example, infrequent users demand machines with lowest possible cost.

To meet the demands of the users, for the purpose of increasing productivity and resolution, the write control unit is configured by increasing the number of semiconductor lasers (LD) serving as light sources or increasing the number of rotations of a polygon motor serving as a deflector. On the other hand, for the purpose of achieving a configuration with low cost, the number of LDs is decreased.

When the number of LDs per color is varied, the number of LDs controlled by a write control IC is varied. Therefore, different write control ICs have to be developed.

In this manner, to meet various demands by the users, a write control IC is developed as an optimal IC for each type of image forming apparatus. This poses a problem of increasing development cost and development load for developing a write control IC for each of many types of image forming apparatus.

### SUMMARY OF THE INVENTION

It is an object of the present invention to at least partially solve the problems in the conventional technology.

According to an aspect of the present invention, an optical writing controller includes a storage unit that includes a plurality of storage areas to store image data, a plurality of image processing units that process the image data, a switch control unit that switches the storage areas to store image data processed by each of the image processing units, and a plurality of write control units that control a writing unit that writes to a recording medium the image data stored in each of the storage areas.

According to another aspect of the present invention, an image forming apparatus includes an optical writing controller and a writing unit. The optical writing controller includes a storage unit that includes a plurality of storage areas to store image data, a plurality of image processing units that process the image data, a switch control unit that switches the storage areas to store image data processed by each of the image processing units, and a plurality of write control units that control the writing unit that writes to a recording medium the image data stored in each of the storage areas. The writing unit writes the image data to the recording medium under control of the write control units.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross section of a multifunction product (MFP) according to a first embodiment of the present invention;

FIG. 2 is a block diagram of an optical writing controller in the MFP;

FIG. 3 is an example of a table stored in a switch control matrix of a write control IC shown in FIG. 2;

FIG. 4 is an example of a table stored in a switch control register of the write control IC;

FIG. 5 is a block diagram of the optical writing controller;

FIG. 6 is a block diagram of an optical writing controller according to a first modification example of the first embodiment;

FIG. 7 is a block diagram of an optical writing controller according to a second modification example of the first embodiment;

FIG. 8 is a block diagram of an optical writing controller including a write control IC applied to a two-color image forming apparatus according to a third modification example of the first embodiment;

FIG. 9 is a block diagram of an optical writing controller including a write control IC applied to a monochrome image forming apparatus according to a fourth modification example of the first embodiment;

FIG. 10 is a schematic for explaining control of clocks inside the write control IC;

FIG. 11 is a block diagram of an optical writing controller including two write control ICs applied to a color image forming apparatus according to a fifth modification example of the first embodiment;

FIG. 12 is a block diagram of an optical writing controller including four write control ICs applied to a color image forming apparatus according to a sixth modification example of the first embodiment;

FIG. 13 is a flowchart of a process of determining a value of the switch control register;

FIG. 14 is a block diagram of an optical writing controller mounted on an MFP according to a second embodiment of the present invention;

FIG. 15 is an example of a table stored in a switch control matrix of a write control IC shown in FIG. 14;

FIG. 16 is an example of a table stored in a switch control register of the write control IC;

FIG. 17 is an example of a table stored in a write-switch control matrix of the write control IC;

FIG. 18 is an example of a table stored in a write-switch control register of the write control IC;

FIG. 19 is a block diagram of the optical writing controller depicting flow of image data;

FIG. 20 is an example of a table stored in the switch control register according to a first modification example of the second embodiment;

FIG. 21 is a block diagram of an optical writing controller depicting flow of image data according to the first modification example of the second embodiment;

FIG. 22 is a schematic for explaining control of clocks inside the write control IC;

FIG. 23 is a block diagram of an optical writing controller including two write control ICs applied to a color image forming apparatus according to a second modification example of the second embodiment;

FIG. 24 is a block diagram of an optical writing controller including four write control ICs applied to a color image forming apparatus according to a third modification example of the second embodiment; and

FIG. 25 is a block diagram of an optical writing controller according to another embodiment of the present invention.

### DETAILED DESCRIPTION OF THE PREFERRED EMBODIMENTS

Exemplary embodiments of the present invention are explained in detail below with reference to the accompanying drawings. In the following description of the embodiments, a write-control integrated circuit and a write controlling apparatus of the present invention are applied to an image forming apparatus and a multifunction product (MFP), which is one type of an image forming apparatus. The present invention, however, is not so limited, and can be applied various apparatuses for writing.

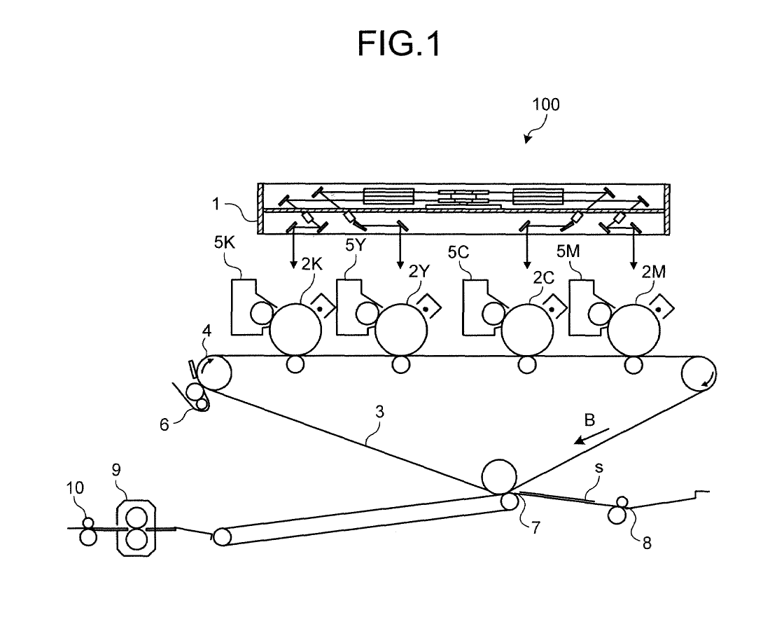

FIG. 1 is a schematic cross section of an MFP 100 according to a first embodiment of the present invention. The MFP 100 includes an optical write unit 1, an intermediate transfer belt 3, intermediate transfer rollers 4, an intermediate transfer belt cleaning device 6, a transferring device 7, paper-feeding resist rollers 8, a fixing device 9, a paper delivering device 10, photosensitive drums 2K, 2Y, 2C and 2M for use in forming images of different colors (yellow: Y, magenta: M, cyan: C, and black: K), and developing devices 5K, 5Y, 5C, and 5M. The photosensitive drums 2K, 2Y, 2C and 2M are aligned along the intermediate transfer belt 3 that conveys a transfer sheet s.

When a user presses a start switch (not shown) of the MFP 100 for starting copy, for example, or when a print request is accepted from a printer host, a print job start signal becomes active, thereby causing a timing-controlled laser beam to be emitted from the optical write unit 1. With the emitted laser beam, exposures to light are performed on the surfaces of the photosensitive drums 2K, 2Y, 2C, and 2M. Then, the developing devices 5K, 5Y, 5C, and 5M cause the photosensitive drums 2K, 2Y, 2C, and 2M corresponding to the respective colors to rotate, respectively, thereby forming a one-color image of each of black (K), yellow (Y), cyan (C), and magenta (M) on each of the photosensitive drums 2K, 2Y, 2C, and 2M.

Concurrently with the operation of causing the photosensitive drums 2K, 2Y, 2C, and 2M to rotate, one of the intermediate transfer rollers 4 causes the intermediate transfer belt 3 to be driven for rotation in a B direction. The other two intermediate transfer rollers rotate as driven rollers according to conveyance of the intermediate transfer belt 3 in the B direction.

The one-color images formed on the photosensitive drums 2K, 2Y, 2C, and 2M are then sequentially transferred to the intermediate transfer belt 3. With this, a composite color image is formed on the intermediate transfer belt 3.

On the other hand, when the job start signal becomes active, transfer sheets from a paper feeding device (not shown) are separated one by one for paper feeding and conveyance, and the paper sheet is then struck against the paper-feeding resist rollers 8 to be temporarily stopped. Then, the paper-feeding resist rollers 8 are rotated so as to match with the timing of the composite color image on the intermediate transfer belt 3, thereby feeding the transfer sheet s between the intermediate transfer belt 3 and the transferring device 7. Then, with the transferring device 7, the composite color image is transferred to the transfer sheet s. The transfer sheet s after transfer is conveyed as it is to the fixing device 9. With the fixing device 9 applying heat and pressure onto the transfer sheet s, the transferred image is fixed.

The transfer sheet s is then delivered by paper-delivery rollers mounted on the paper delivering device 10 and is stacked on a paper delivery tray (not shown).

The optical write unit 1 drives two polygon mirrors by one polygon motor (not shown), thereby emitting write laser light with a laser diode as a light source. The optical write unit 1 performs optical writing onto the photosensitive drums 2K, 2Y, 2C, and 2M, thereby forming a latent image. Each unit or device is an image forming component of an electrophotographic type and has a configuration already known, and is not explained herein. The optical write unit 1 has a configuration of an optical writing controller. Next, such an optical writing controller that controls laser light to be emitted from the optical write unit 1 is explained.

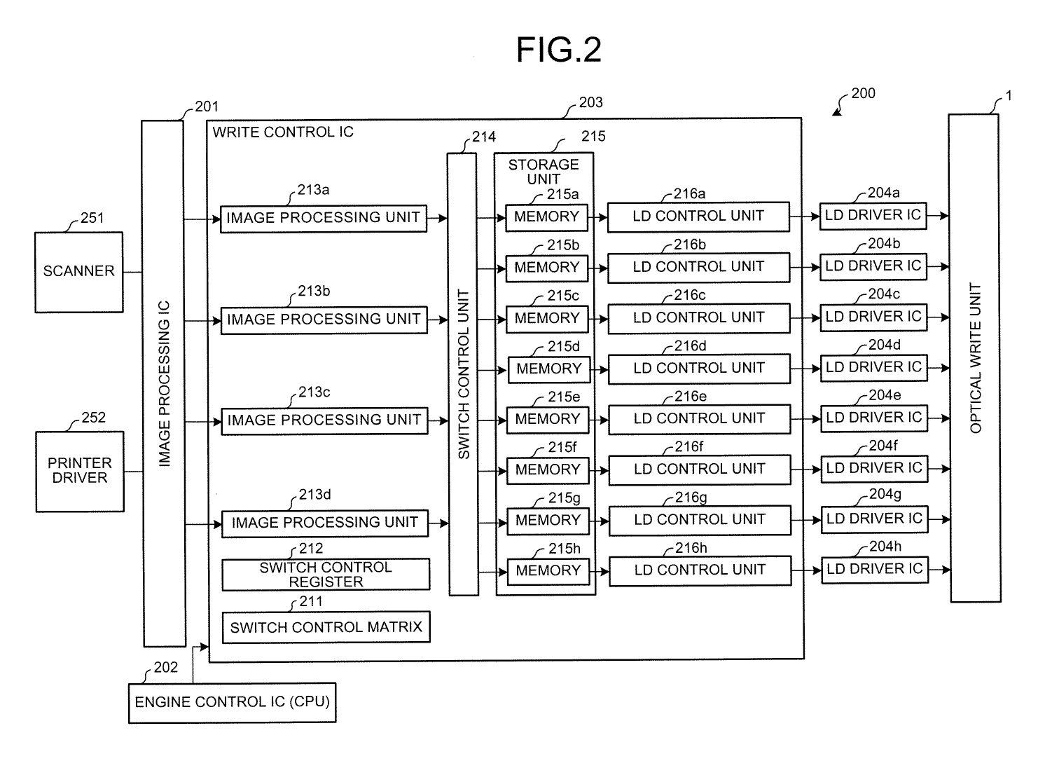

FIG. 2 is a block diagram of an optical writing controller 200 included in the MFP 100. With the optical writing controller 200 controlling laser light, optical writing can be performed. The optical writing controller 200 includes an image processing IC 201, an engine control IC 202, a write control IC 203, LD driver ICs 204a to 204h, and the optical write unit 1, and controls optical writing based on an image data signal input from a scanner 251 or a printer driver 252.

In the optical writing controller 200, when a job start signal becomes active, an image data signal is output from the scanner or the printer driver 252. Based on the image data signal, optical write control is started.

The engine control IC 202 controls the MFP 100 and also sets parameters for various controls. The engine control IC 202 also outputs information required for updating a switch control register 212, which is explained further below. The output information will also be explained further below.

The image processing IC 201 performs various image processes, such as a color conversion process from RGB to CMYK, rotation, or editing, on the image data signal input from the scanner 251 or the printer driver 252. After various image processes are performed, an output is produced to the write control IC 203.

The write control IC 203 includes a switch control matrix 211, the switch control register 212, image processing units 213a to 213d, a switch control unit 214, a storage unit 215, and LD control units 216a to 216h. The write control IC 203 processes image data from the image data signal input from the image processing IC 201, and controls LD driver ICs 204a to 204h to form images. The write control IC 203 also includes a clock control unit and an LD clock control unit, which are explained further below.

The storage unit 215 includes memories 215a to 215h to store image data processed by the image processing units 213a to 213d, which are explained further below, and holds the image data until it is transferred to the LD control units 216a to 216h, which are explained further below.

The memories 215a to 215h according to the embodiment are associated in advance with the LD control units 216a to 216h. The memories 215a to 215h have temporarily stored therein the image data processed by the image processing units 213a to 213d. With this, the LD control units 216a to 216h can obtain image data stored at a predetermined timing suitable for write control.

The memories 215a to 215h are each configured of a First Input First Out (FIFO) memory. That is, the LD control units 216a to 216h can obtain the image data stored in the image processing units 213a to 213d in sequence from the head before the final data is stored.

In a memory not in a FIFO configuration, generally speaking, storing is performed from the head data and the head data cannot be output until the final data is stored. Therefore, a memory capacity of a certain unit is required. That is, from the feature of the image data handled at the write control IC 203, each memory is required to have a memory capacity allowing image data for one line in a main scanning direction to be stored.

On the other hand, the memories 215a to 215h according to the embodiment are in a FIFO configuration, and therefore, data can be easily extracted in the order they are stored. For this reason, a memory capacity for one line in the main scanning direction is not required, and the capacitance of the memories 215a to 215h can be reduced. With this, manufacturing cost of the write control IC 203 can be reduced.

In conventional technologies, a beam pitch is adjusted in the main scanning direction of each light-emitting element of a plurality of light sources, such as laser diode amplifiers (LDAs), with one device. The memories 215a to 215h can be replaced by a memory mounted on one device already achieved. That is, a new memory does not have to be mounted to manufacture the write control IC 203. Therefore, the functions can be achieved without increasing cost.

The switch control matrix 211 holds a corresponding relation between the image processing units 213a to 213d and the memories 215a to 215h serving as storage destinations of image data processed by the image processing units 213a to 213d. Also, the switch control matrix 211 is assumed to be stored in a non-rewritable memory (not shown) included in the write control IC 203, that is, a correspondence storage unit.

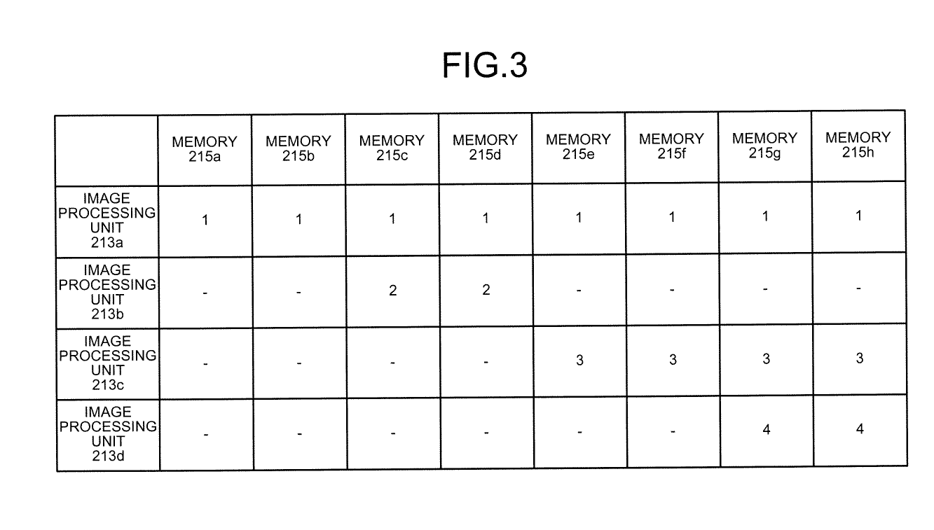

FIG. 3 is an example of a table stored in the switch control matrix 211. The switch control matrix 211 holds a correspondence relation between the image processing units 213a to 213d and the memories 215a to 215h. In the switch control matrix 211, values of 1 to 4 are set only to a combination in which the image processing units 213a to 213d can hold image data.

Referring back to FIG. 2, the switch control register 212 holds the values of 1 to 4 set in the table of the switch control matrix 211.

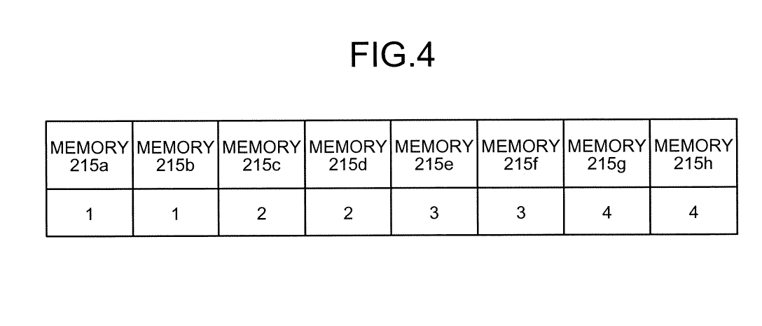

FIG. 4 is an example of a table stored in the switch control register 212. The switch control register 212 stores therein values of 1 to 4 for each of the memories 215a to 215h. It is assumed that these values of 1 to 4 correspond to the values of 1 to 4 stored in the switch control matrix 211 shown in FIG. 3. That is, by referring to the switch control matrix 211 based on the values set in the switch control register 212, any of the memories 215a to 215h can be specified as a storage destination of the image data processed by the relevant one of the image processing units 213a to 213d. The switch control register 212 is assumed to be stored in a rewritable memory (not shown) included in the write control IC 203, that is, a specification storing unit.

In the example of FIG. 4, the memories 215a and 215b are set at “1”, and serve as storage destinations for the image processing unit 213a. On the other hand, the memories 215c and 215d are set at “2”, and serves as storage destinations for the image processing unit 213b. Here, the memories 215e to 215h can be each specified as a storage destination in a manner similar to the above.

Furthermore, the values of the switch control matrix 211 are updated by the write control IC 203 referring to the switch control matrix 211 based on information transmitted from the engine control IC 202. It is assumed that the transmitted information is information required for specifying a storage destination of image data processed by any of the image processing units 213a to 213d and includes, for example, the number of formed images to be processed by the write control IC 203 and the number of LDs per color.

Referring back to FIG. 2, the image processing units 213a to 213d processes image data from an image data signal for each color input from the image processing IC 201. The image processing units 213a to 213d can be configured to have a special function according to the color to be handled. Such a function is explained further below.

The switch control unit 214 performs switching control so as to store the image data processed by any of the image processing units 213a to 213d in a predetermined one of the storage destination memories 215a to 215h. The switch control unit 214 can also specify a memory serving as a storage destination of the image data processed by any of the image processing units 213a to 213d by referring to the switch control register 212 and the switch control matrix 211. The switch control unit 214 performs switching control accordingly.

The LD control units 216a to 216h obtains image data stored in the memories 215a to 215h, respectively, and controls the LD driver ICs 204a to 204h based on obtained image data. With this, LDs can write the image data. Also, the LD control units 216a to 216h perform format conversion on the image data according to the specifications of the LD driver ICs 204a to 204h to control the LD driver ICs 204a to 204h, and outputs the image data when appropriate.

The LD control units 216a to 216h are configured according to common specifications irrespectively of color in which an image is to be formed. That is, since a different function depending on the image-forming color is provided to the image processing units 213a to 213d, commonality of the LD control units 216a to 216h can be achieved. The functions provided to the image processing units 213a to 213d are explained further below. Also, with the LD control units 216a to 216h being according to the common specifications, the developing period can be reduced and development efficiency can be increased.

Meanwhile, as explained above, conventional write control ICs are configured independently for each color in an image forming apparatus. For example, a color image forming apparatus that forms images with four colors of CMYK has mounted thereon four identical write control ICs. Each of these write control IC includes an image processing unit and an LD control unit, and an LD driver IC is controlled according to an image data signal of each color input from the write control IC. In such a configuration of independent write control ICs for respective colors, to prevent a color shift or the like, the write control IC processes image data from the input image data signal with reference to a main scanning timing signal called a synchronization detection signal from a optical write unit, and then outputs the image data to the LD driver IC.

In such a conventional technology, the write control ICs identical in configuration are used for respective colors. Therefore, the conventional write control IC even covers a function of using a specific color. This means that the write control IC performing LD control according to a predetermined image-forming color even includes a function not used for the image-forming color. For this reason, the write control IC invites redundancy due to such a group of functions. Furthermore, as a result of redundancy, the number of transistors of ICs is increased.

An example of a function included in the conventional write control IC but not required for each color is a function of managing a timing of writing all colors. This function is such that, when a system operation start signal is input to a predetermined write control IC from an engine control unit that performs timing control over the entire image forming apparatus, the write control IC generates a signal for starting the operation of the write control unit in synchronization with the write control timing, thereby generating and managing timing of controlling the LD for each write control IC.

This function is required because the system operation start signal from the engine control unit and the write control timing are asynchronous signals. If the write control timing is not managed, the write control timings for all colors cannot be synchronized with one another, thereby causing a color shift in a sub-scanning direction. For this function, however, one write control IC is enough to manage the timing. However, in the conventional image forming apparatus, the identical write control ICs are mounted as many as the number of image-forming colors, and the plurality of write control ICs have this function, resulting in a redundant configuration.

In contrast, in the write control IC 203 according to the embodiment, write control units which have been independent for each color are unified into one chip. The write control IC 203 includes the image processing units 213a to 213d for respective colors, and therefore, it is not required to configure the image processing units 213a to 213d so that they have a common configuration. With this, redundancy of functions included in the ICs can be prevented, and production cost can be reduced.

The write control IC 203 includes eight LD control units 216a to 216h and their corresponding memories 215a to 215h. The write control IC 203 also includes four image processing units 213a to 213d. Therefore, the MFP 100 including one write control IC 203 can write four image-forming colors at maximum with eight LDs at maximum. That is, with four image-forming colors in the MFP 100, there are two LDs drivable per color.

The write control IC 203 can change the number of LDs to be controlled according to the number of image-forming colors and the number of LDs for use per color. Assuming that the number of image-forming colors is m and the number of LDs for use per color is n, the number of LDs to be controlled by the write control IC 203 is m×n. Since the write control IC 203 according to the embodiment includes only eight LD control units, it is required to be designed so that m×n is equal to or lower than eight.

The LD driver ICs 204a to 204h each drive a laser diode (LD) connected to the optical write unit 1 according to the image data input from the write control IC 203 and exposes a relevant one of the photosensitive drums 2K, 2Y, 2C, and 2M to a laser beam to form a electrostatic latent image.

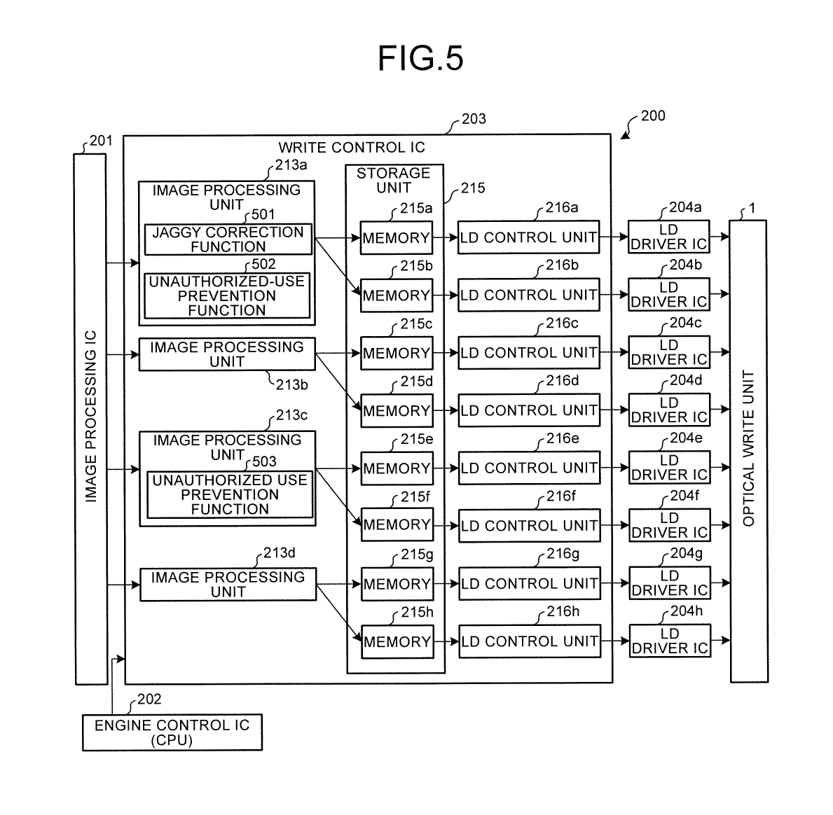

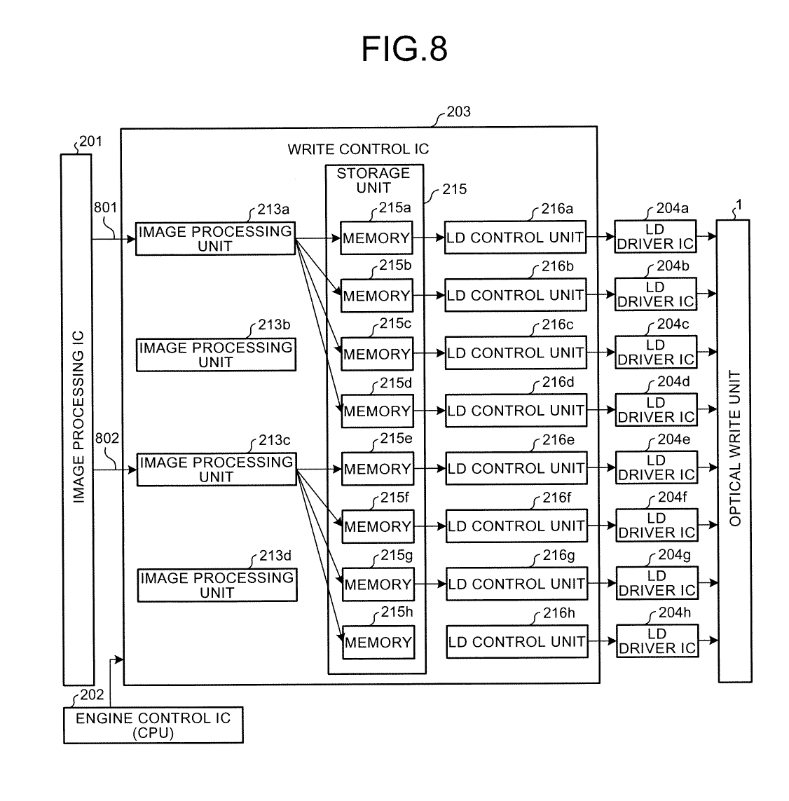

FIG. 5 is a block diagram of the optical writing controller 200 depicting functions of the image processing units 213a to 213d and flow of image data. In the optical writing controller 200 shown in FIG. 5, it is assumed that two LDs are used per image-forming color, and the switch control unit 214 is omitted so that the storage destinations of the image data processed by the image processing units 213a to 213d can be visually recognized with ease. Similarly, the switch control unit 214 is omitted in FIG. 8 and onward. It is also assumed that the image data is transmitted and received along routes represented by arrows from the image processing IC 201 to the optical write unit 1, and the same goes for subsequent drawings.

As shown in FIG. 5, the image processing unit 213a has a jaggy correction function 501 and an unauthorized-use prevention function 502. The image processing unit 213c has an unauthorized-use prevention function 503.

Meanwhile, the MFP 100 supports not only color images formed with plural colors but also monochrome images formed only with black. For such monochrome images, a unique function necessary only for image formation with black is required. For example, when image data with low resolution at the time of receiving facsimile (such as 100 dots per inch, 200 dots per inch, or 300 dots per inch) is converted to image data with high resolution (such as 600 dots per inch or 1200 dots per inch), if the pixels are simply increased to be a desired multiple, jaggy steps are formed at edge portion of the image, such as a slanting line. To get around this, a process of detecting a specific target pattern portion, such as a slanting line, and smoothing its edge portion is required. The function performing such a process is the jaggy correction function 501.

Only the image processing unit 213a is the one for image formation with black, and the image processing unit 213a includes the jaggy correction function 501. With this, only the image processing unit 213a includes the jaggy correction function 501, whilst the other image processing units 213b to 213d do not, thereby optimizing function distribution.

Meanwhile, conventional color image forming apparatuses have a function of forming a latent watermark image to prevent forgery and unauthorized use of paper money and stock certificates to achieve security. When copying or the like by using a recording sheet with the latent watermark image, the image forming apparatus as an output source can be differentiated from the others by using optical scanning. A pattern dedicated for this differentiating function is assumed to be generated with a specific color, and therefore, such a function is not required for the other colors. Thus, in the write control IC 203, only the image processing units 213a and 213c that possibly form images with yellow include the unauthorized-use prevention function, whilst the other image processing units 213b and 213d do not. In this manner, the write control IC 203 can optimize function distribution.

In the embodiment, it is assumed that only when image-forming colors are black and yellow, the specific functions are used. That is, the image processing unit 213a includes the jaggy correction function 501 and the unauthorized-use prevention function 502, and is capable of processing image data irrespectively of the image-forming color. The image processing unit 213c includes the unauthorized-use prevention function 503, and is capable of processing image data only when the image-forming color is any of yellow, cyan, and magenta. The image processing units 213b and 213d do not include specific functions, and can process image data only when the image-forming color is any of cyan and magenta.

Because the write control IC 203 has the image processing unit 213a that includes a function supporting black, the write control IC 203 can be applied not only to color image forming apparatuses but also to monochrome image forming apparatuses.

As described above, the image processing units 213a to 213d included in the write control IC 203 include functions supporting plural colors. With this, with one type of the write control IC 203, applications to various image forming apparatus with different write controls can be achieved. For example, with a plurality of the write control ICs 203 mounted on an image forming apparatus, more LDs can be controlled, thereby achieving high speed. Various examples of application of the write control ICs 203 to different image forming apparatuses are discussed further below.

In this manner, in the write control IC 203, a different function according to the image-forming color is disposed in the image processing units 213a to 213d. With this, functional specialization can be achieved. Also, the image processing units 213a to 213d each do not have the identical function, but functions are distributed according to the image-forming color. With this, redundancy in the write control IC 203 can be prevented. Furthermore, the write control IC 203 can be produced at low cost.

The functions of the image processing units 213a to 213d are not to be restricted to those shown in FIG. 5. Modification examples in which the image processing units 213a to 213d have functions different from those described in the first embodiment are explained next.

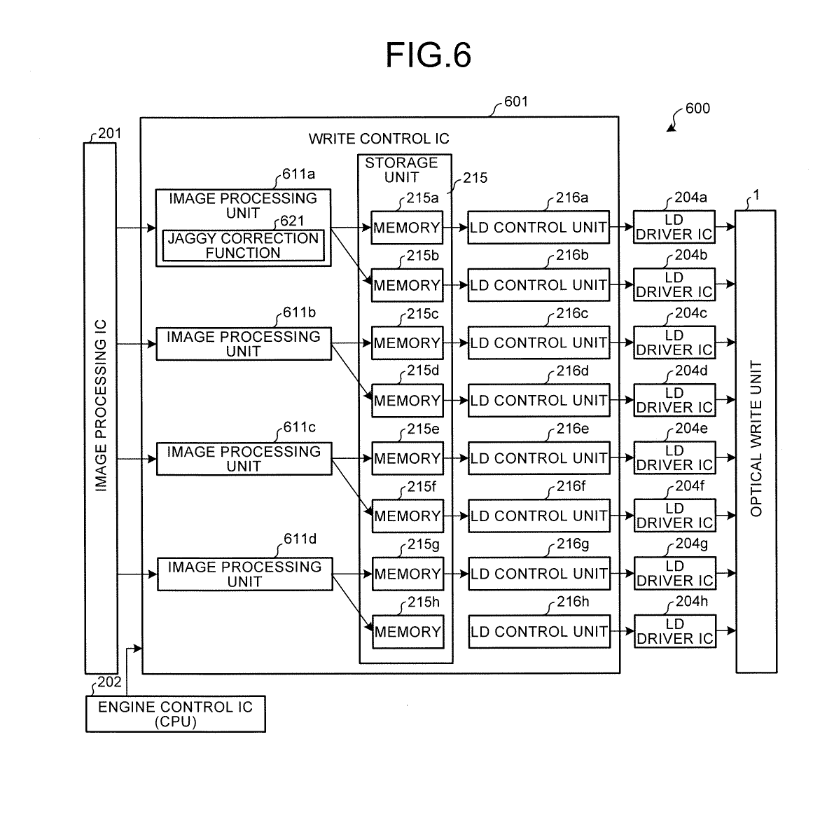

FIG. 6 is a block diagram of an optical writing controller 600 depicting functions of image processing units 611a to 611d and flow of image data according to a first modification example of the first embodiment. As shown in FIG. 6, only the image processing unit 611a includes a jaggy correction function 621. Therefore, jaggies can be corrected at the time of processing monochrome image data. Also, as a matter of course, the optical writing controller 600 can also control LDs by using color image data. However, the image processing units 611b to 611d do not include any special function, that is, they do not include an unauthorized-use prevention function, and a latent watermark image cannot be formed on the background to prevent unauthorized use.

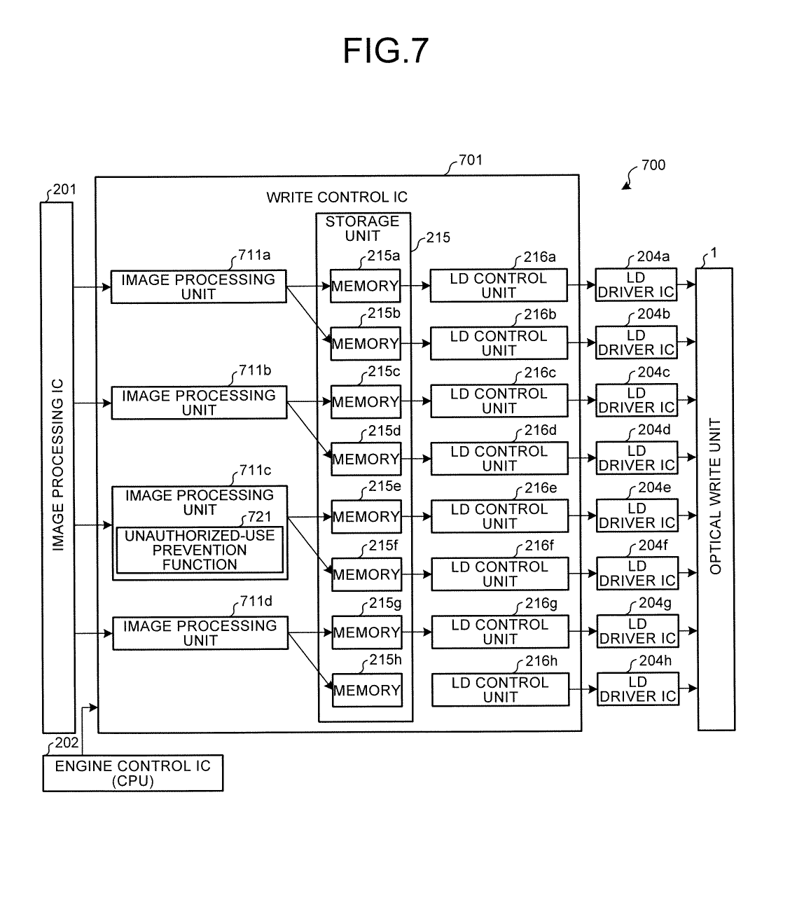

FIG. 7 is a block diagram of an optical writing controller 700 depicting functions of image processing units 711a to 711d and flow of image data according to a second modification example of the first embodiment. As shown in FIG. 7, only the image processing unit 711c includes an unauthorized-use prevention function 721. With the image processing unit 711c including the unauthorized-use prevention function, a latent watermark image can be formed on the background to prevent unauthorized use. However, the unauthorized-use prevention function 721 can be used only when the image-forming color is yellow, and a latent watermark image can be formed only when the image processing unit 711c processes image data in yellow. That is, when the image processing units 711a, 711b, and 711d process image data in yellow, a latent watermark image cannot be formed.

The image processing units 711a to 711d do not include a jaggy correction function. Therefore, when monochrome image data is processed, jaggies cannot be corrected.

Referring back to FIG. 5, the process routes of the image data in the optical writing controller 200 are explained. In the optical writing controller 200, it is assumed that the MFP 100 forms images with four colors, and two LDs are used per image-forming color.

In the optical writing controller 200, black (K) corresponds to the image processing unit 213a, cyan (C) corresponds to the image processing unit 213b, yellow (Y) corresponds to the image processing unit 213c, and magenta (M) corresponds to the image processing unit 213d. The image processing units 213a to 213d are connected to two of the memories 215a to 215h by the switch control unit 214, and outputs image data to relevant ones of the LD control units 216a to 216h connected in association with the memories 215a to 215h. That is, image data of black (K) is store in the memories 215a and 215b, image data of cyan (C) is stored in the memories 215c and 215d, image data of yellow (Y) is stored in the memories 215e and 215f, and image data of magenta (M) is stored in the memories 215g and 215h, thereby controlling two LDs for each image-forming color. With such usage, a color image forming apparatus of an intermediate-speed class with two LDs being controlled for each image-forming color can be achieved with one write control IC 203.

In the write control IC 203, as shown in FIG. 2, the switch control unit 214 can switch connections among four image processing units 213a to 213d and the eight LD control units 216a to 216h. That is, the write control IC 203 can be generally mounted on a plurality of types of image forming apparatus with different numbers of image-forming colors and LDs to be controlled. Furthermore, even in the same image forming apparatus, the number of LDs to be controlled for each image-forming color can also be changed according to the number of image-forming colors. A case is next explained in which the write control IC 203 is applied to an apparatus other than the MFP 100.

FIG. 8 is a block diagram of an optical writing controller including the write control IC 203 applied to a two-color image forming apparatus according to a third modification example of the first embodiment. The image forming apparatus of the third modification example is assumed to form images with two colors, black and red. That is, from the image processing IC 201, black image data is input to the image processing unit 213a as represented by an arrow 801, whilst red image data is input to the image processing unit 213c as represented by an arrow 802. Thus, although the image forming apparatus according to the present modification example can have mounted thereon a write control IC having only two image processing units, in consideration of commonality of the other image forming apparatuses, the image forming apparatus has mounted thereon a write control IC having four image processing units 213a to 213d.

The image processing unit 213a processes the black image data, whilst the image processing unit 213c processes the red image data. The switch control unit 214 connects in advance the image processing unit 213a to the memories 215a to 215d and the image processing unit 213c to the memories 215e to 215h. With this, the image forming apparatus according to the modification example performs a writing process with four LDs per color. In the image forming apparatus according to the modification example, with the write control IC 203 being mounted thereon, commonality of components with other image forming apparatuses can be achieved, and a printing process can be performed at high speed.

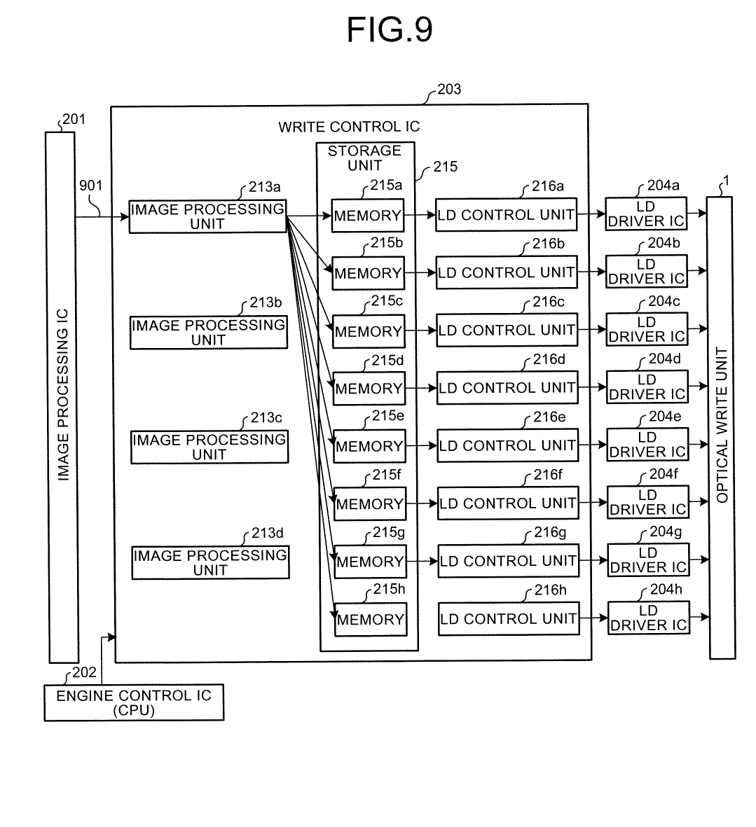

FIG. 9 is a block diagram of an optical writing controller including the write control IC 203 applied to a monochrome image forming apparatus according to a fourth modification example of the first embodiment. From the image processing IC 201, black image data is input to the image processing unit 213a as represented by an arrow 901. Similarly, in the monochrome image forming apparatus, in consideration of commonality of the other image forming apparatuses, the write control IC 203 having four image processing units 213a to 213d is mounted.

In the monochrome image forming apparatus, a high productivity is normally demanded, and image data with high density of resolution is output. Thus, in the fourth modification example, the switch control unit 214 connects in advance the image processing unit 213a to eight memories 215a to 215h. That is, the monochrome image forming apparatus performs a writing process with eight LDs per color. With this, in the monochrome image forming apparatus, with the write control IC 203 being mounted thereon, commonality of components with other image forming apparatuses can be achieved, and a printing process can be performed at higher speed.

As discussed above, in the write control IC 203, connections between the image processing units 213a to 213d and the LD control units 216a to 216h are switchable by the switch control unit 214. With this, the write control IC 203 can be applied to various types of image forming apparatus.

If the switch control unit 214 allows all the image processing units 213a to 213d and all the LD control units 216a to 216h to be arbitrarily connected, a selector for switching in the switch control unit 214 will generate a large amount of circuit configuration. To avoid this, by supporting only the connections of the image forming apparatus in which the switch control unit 214 is actually mounted, the circuit configuration of the switch control unit 214 can be optimized. Next, the selector for switching included in the switch control unit 214 is explained.

First, the image processing unit 213a is required to be able to be connected to all the memories 215a to 215h included in the write control IC 203 to be mounted on a high-speed monochrome image forming apparatus according to the fourth modification example of the first embodiment shown in FIG. 9. Therefore, the switch control unit 214 has a circuit configuration in which the image processing unit 213a can be connected to all the memories 215a to 215h. On the other hand, the other image processing units 213b to 213d do not have to be connected to all the memories 215a to 215h. The reason is as follows. That is, when all memories are used, only the image processing unit 213a is enough to process the image, and the other image processing units 213b to 213d do not inevitably process the image. If the other image processing units 213b to 213d also process the image, the circuit configuration is complex.

Furthermore, as in the third modification example of the embodiment shown in FIG. 8, there may be the case where eight LD control units 216a to 216h are used by the two image processing units. In this case, the image processing unit 213c is required to be able to be connected to four LD control units 216e to 216h. Thus, the switch control unit 214 has a circuit configuration in which the image processing unit 213c can be connected to the memories 215e to 215h. Here, the image processing unit 213a can be connected to all the memories 215a to 215h as explained above, and can be connected to the four memories 215a to 215d, as a matter of course.

Furthermore, as shown in FIG. 5, there may be the case where eight LD control units 216a to 216h are used by the four image processing units 213a to 213d. Thus, the switch control unit 214 has a circuit configuration in which the image processing unit 213b can be connected to the memories 215c and 215d and the image processing unit 213d can be connected to the memories 215g and 215h. With such a circuit configuration, connections are uniquely defined. Also, with the switch control unit 214 performing only switching of connections, a storage destination of the image data processed by any of the image processing units 213a to 213d can be changed.

Thus, with one write control IC 203 being mounted, a high monochrome image forming apparatus, an image forming apparatus with two-color image formation, and a color image forming apparatus of an intermediate-speed machine class can be achieved.

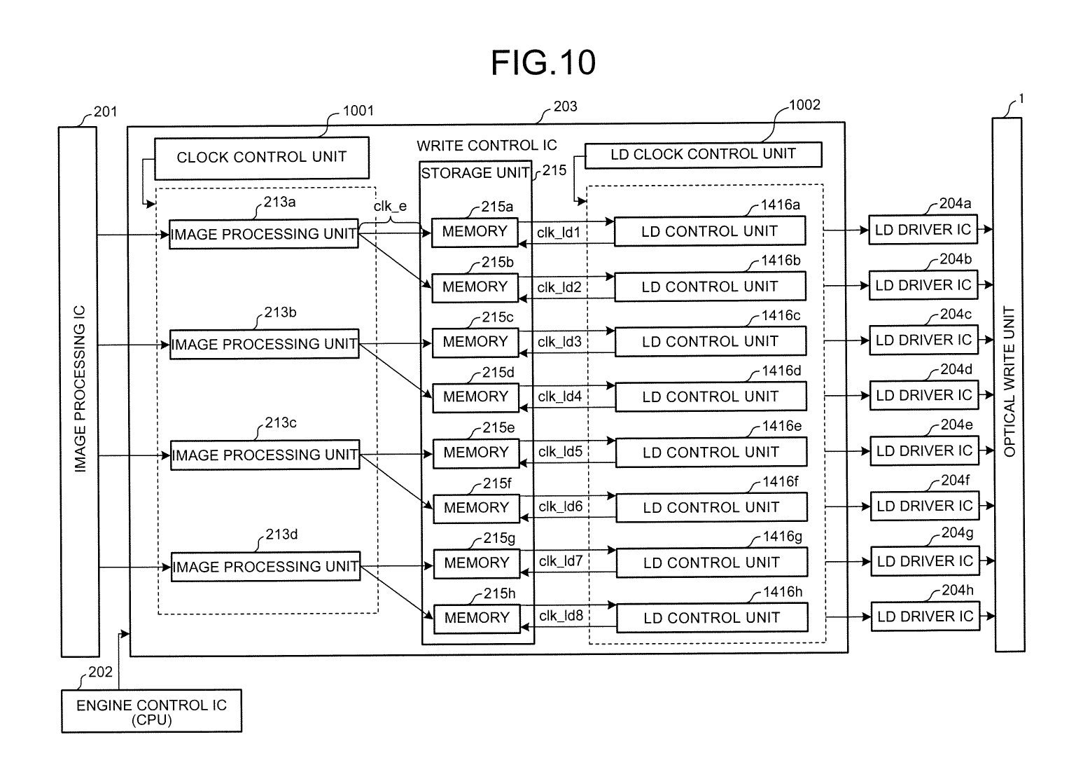

FIG. 10 is a schematic for explaining control of clocks inside the write control IC 203. As shown in FIG. 10, a clock control unit 1001 controls operation clocks of the image processing units 213a to 213d, whilst an LD clock control unit 1002 controls operation clocks of the LD control units 216a to 216h.

The LD clock control unit 1002 controls the LD control units 216a to 216h with clock signals clk_ld1 to clk_ld8, respectively, in synchronization with a synchronization detection signal of each LD. That is, the LD control units 216a to 216h are controlled by different individual clock signals.

The image processing units 213a to 213d can be controlled by another clock. Thus, the clock control unit 1001 controls the image processing units 213a to 213d with a same clock signal clk_e.

That is, with the clock signal clk_e, the image processing units 213a to 213d process image data, and then write them in the memories 215a to 215h, respectively. In this case, the image processing units 213a to 213d perform a write operation with this clock signal clk_e, and therefore, the write operations of all the image processing units 213a to 213d on the memories 215a to 215h can be synchronized with one another.

The image data written in the memories 215a to 215h are then read and the LDs are controlled by the LD control units 216a to 216h according to the clock signals clk_ld1 to clk_ld8, respectively. Specifically, the LD control unit 216a performs a reading process and other processes with clk_ld1, the LD control unit 216b performs a reading process and other processes with clk_ld2, . . . , and the LD control unit 216h performs a reading process and other processes with clk_ld8.

Here, the clocks for a write operation of the image processing units 213a to 213d and the clocks for a read operation of the LD control units 216a to 216h are not synchronized with each other. However, with the memories 215a to 215h being interposed therebetween, image data can be transmitted and received.

Furthermore, clock signals when the LD control units 216a to 216h read from the memories 215a to 215h are multi-clock signals, clk_ld1 to clk_ld8. This is because a read operation side supports several types of image forming apparatus with different writing timings and others. However, since the connections between the LD control units 216a to 216h and the memories 215a to 215h are uniquely defined, a reading process can be performed for each memory with the fixed clock signals.

In the embodiment, the clocks of the LD control units are assumed to be those with the same frequency, and be varied only in phase according to the writing timing of the LD driver ICs 204a to 204h. Here, the embodiment is not meant to be restricted to such a case as that the clocks of the LD control units are varied only in phase, and various embodiments can be thought according to the actual hardware configuration. In one example, the clocks of the LD control units may have different frequencies.

In this manner, with the LD control units 216a to 216h being controlled with the fixed clock signals, a simple circuit configuration can be achieved without forming a complicated asynchronous circuit with different types of clock signals.

Furthermore, the LD clock control unit 1002 according to the embodiment generates separate clocks for the LD control units 216a to 216h. Alternatively, the LD clock control unit 1002 may generates a whole clock. When a whole clock is generated, from the generated clock, the clock signal clk_ld1 to clk_ld8 are output to the LD control units 216a to 216h, respectively, at appropriate timing. Here, since only the LD clock control unit 1002 generates a clock for all the LD control units 216a to 216h, a delay of only the clock signal to an arbitrary LD control unit is prevented.

Still further, according to the first embodiment and its modification examples explained above, one write control IC 203 is mounted on the MFP or the image forming apparatus. However, the number of the write control ICs is not meant to be restricted to one for each apparatus. Alternatively, a plurality of the write control ICs 203 can be mounted on an image forming apparatus. A modification example is explained in which a plurality of the write control ICs 203 is mounted on an image forming apparatus.

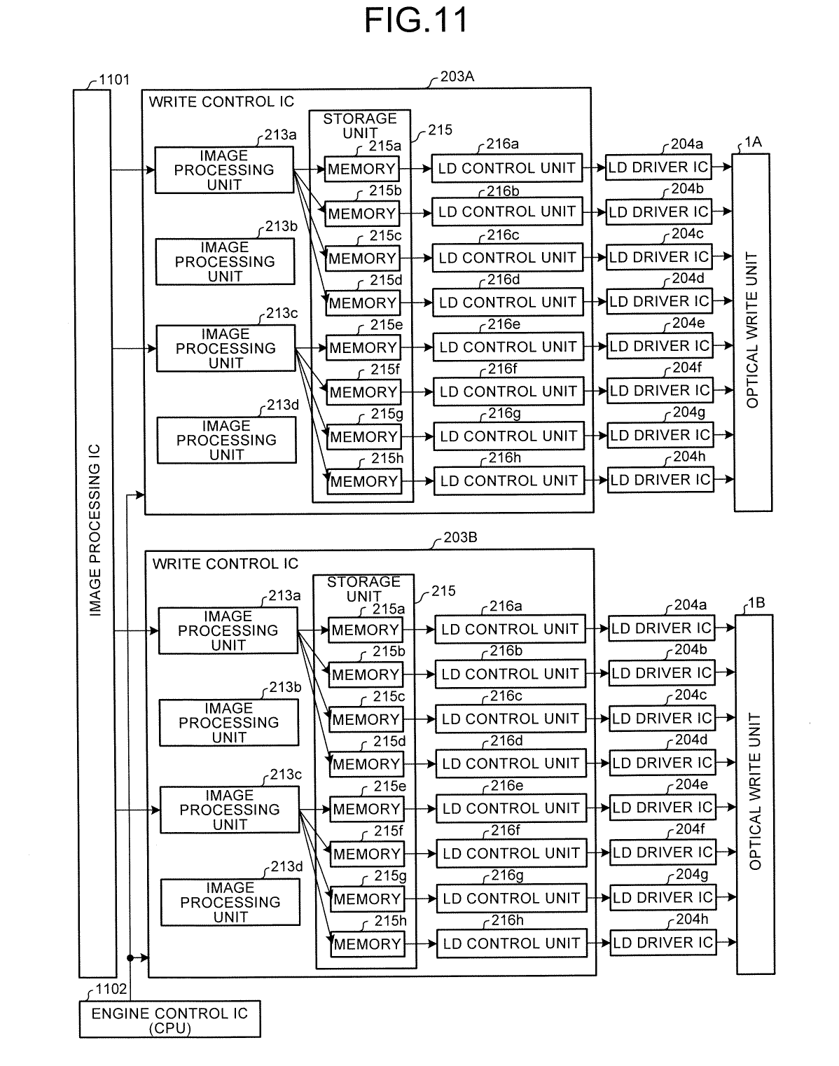

FIG. 11 is a block diagram of an optical writing controller including two write control ICs 203A and 203B applied to a color image forming apparatus according to a fifth modification example of the first embodiment. With the write control ICs 203A and 203B being mounted on the color image forming apparatus, even with four image-forming colors, the number of LDs that can be drive-controlled per color is four. An image processing IC 1101 outputs different image data signals of two colors to the write control IC 203A and the write control IC 203B. An engine control IC 1102 outputs information required for updating the switch control register 212 to each of the write control IC 203A and the write control IC 203B.

With one write control IC 203, eight LDs can be controlled at maximum. However, for a printing process at high speed, eight or more LDs may be desired to be drive-controlled. This can be achieved by mounting a plurality of the write control ICs 203 on the image forming apparatus. In the present modification example, it is assumed that the number of image-forming colors is four, and four LDs are desired to be driven per color. In this case, four colors×four LDs=16 LD control units are required. Therefore, one image forming apparatus is achieved by using two write control ICs 203.

In the present modification example, the image processing unit 213a of the write control IC 203A processes image data of black, the image processing unit 213c of the write control IC 203A processes image data of cyan, the image processing unit 213a of the write control IC 203B processes image data of yellow, and the image processing unit 213c of the write control IC 203B processes image data of magenta.

In this manner, the image processing units 213a and 213c process image data of an image-forming color different from that in the case when one write control IC 203 is mounted on the image forming apparatus. Therefore, the image processing units 213a and 213c are required to have a function according to the image-forming color to be processed when two write control ICs 203 are mounted. Thus, the image processing unit 213a includes in advance the jaggy correction function 501 and the unauthorized-use prevention function 502 as explained in FIG. 5. With this, the image processing unit 213a of the write control IC 203B shown in FIG. 11 can form a latent watermark image when image data of yellow is processed. Furthermore, the image processing unit 213a of the write control IC 203A can correct jaggies when processing image data of black.

The image processing unit 213a includes not only a function when the image-forming color is black but also a function for use only in other colors. That is, the image processing unit 213a can process image data of all image-forming colors. Furthermore, the image processing unit 213c includes not only a function when the image-forming color is yellow but also a function for use in cyan and magenta. With this, the color image forming apparatus with two write control ICs 203 mounted thereon can achieve high speed by using four LDs per image-forming color, and also can perform a printing process by using a specific function for each image-forming color.

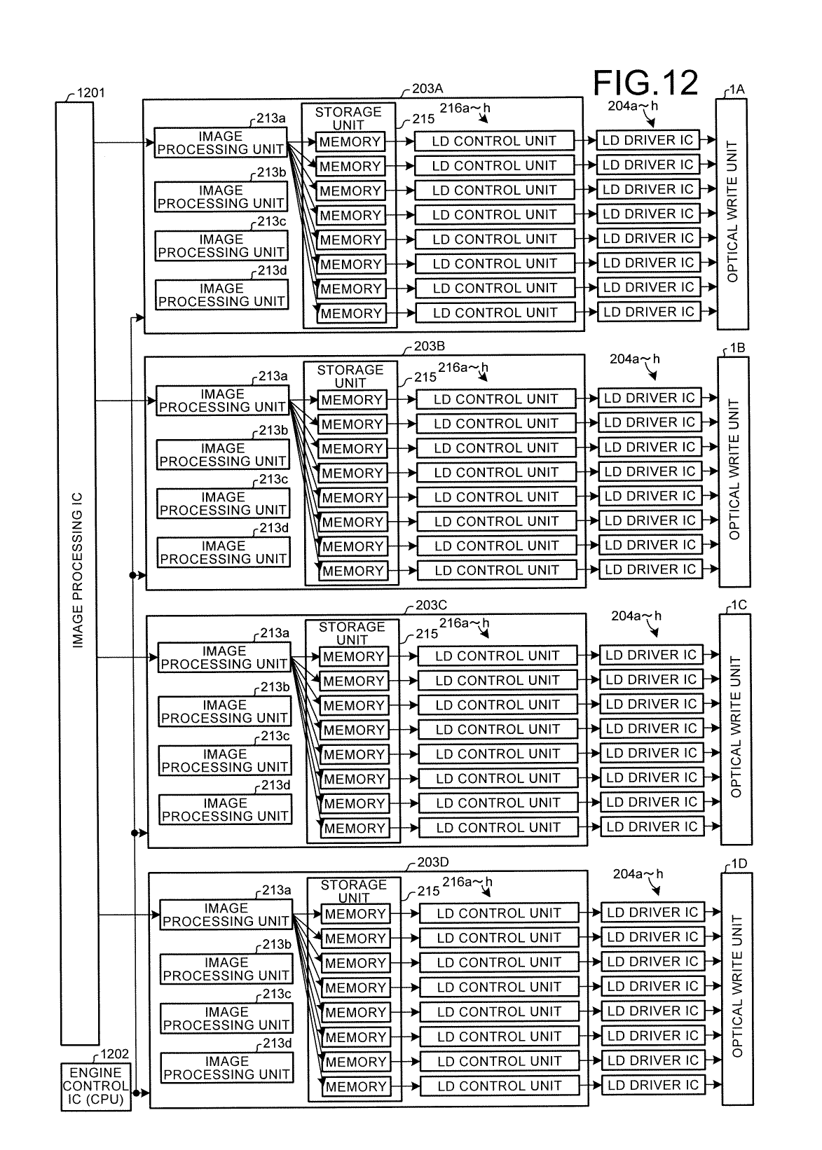

FIG. 12 is a block diagram of an optical writing controller including four write control ICs 203A to 203D applied to a color image forming apparatus according to a sixth modification example of the first embodiment. The color image forming apparatus has mounted thereon the write control ICs 203A, 203B, 203C, and 203D. With this, when the number of image-forming colors is four, the number of LDs that can be driven-controlled per color is eight. An image processing IC 1201 outputs a different image data signal of single color to each of the write control ICs 203A, 203B, 203C, and 203D. An engine control IC 1202 outputs information required for updating the switch control register 212 to each of the write control ICs 203A, 203B, 203C, and 203D.

As shown in FIG. 12, since one write control IC 203 is mounted for each image-forming color, the number of LDs per color is eight. With this, the image forming apparatus can achieve a much higher speed.

The image processing units 213b to 213d shown in FIG. 12 seem to have a redundant configuration. However, with such a configuration, the write control IC 203 can be applied to a plurality of different types of machines. Thus, with commonality of components, development efficiency can be increased, and cost can be reduced.

The modification example shown in FIG. 12 is similar to the configuration of the conventional technology with one write control IC 203 being mounted per color. However, to change connections between the image processing units 213a to 213d and the LD control units 216a to 216h, the switch control unit 214 and the memories 215a to 215h are included in the present modification example. With this, the write control IC 203 can be mounted on various types of other image forming apparatuses.

Although different from the embodiment, an alternative embodiment may be such that, to prevent redundancy caused by disposing the function for use with only a specific color onto a plurality of image processing units, a common function unit may be provided separately from each of the image processing units of the respective colors. With this, an image processing unit that processes an image of a specific color can use the common function unit to perform the function corresponding to the specific color. With this, redundancy can be suppressed.

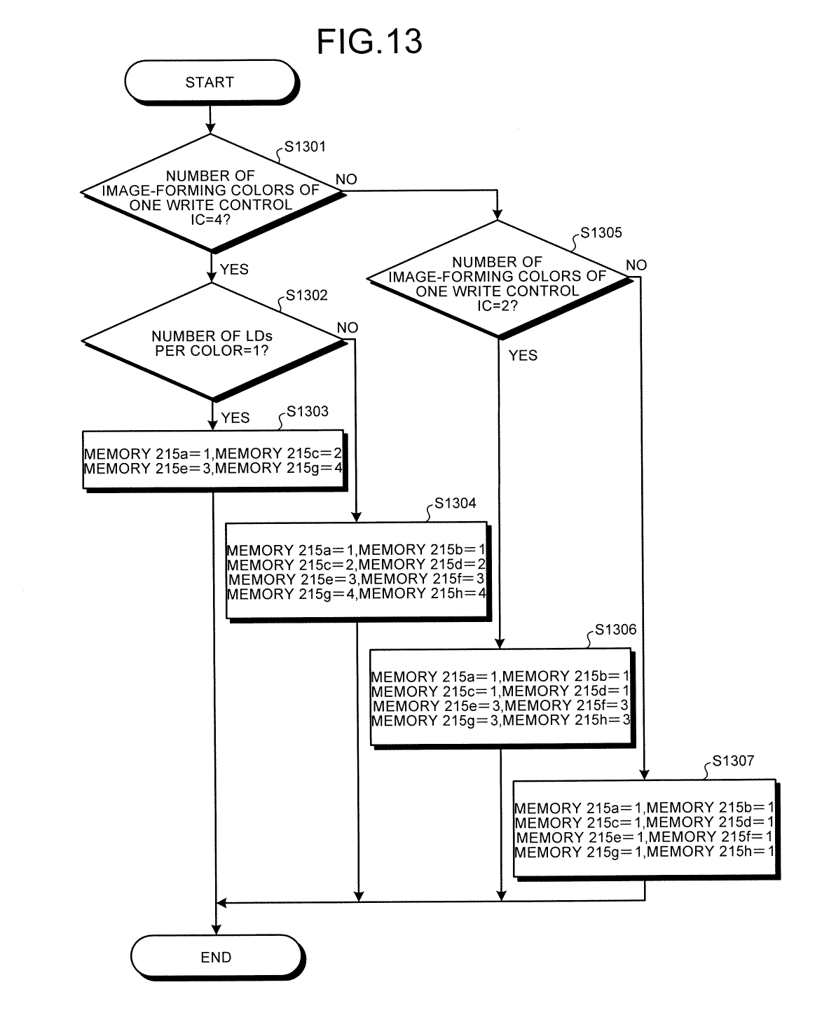

Next, a process of determining a value of the switch control register 212 of the write control IC 203 configured as above is explained. FIG. 13 is a flowchart of the operation of the write control IC 203. This operation is performed when the number of image-forming colors or the number of LDs for use are input from the engine control IC 202 to the write control IC 203.

First, the write control IC 203 determines whether the number of image-forming colors to be processed by the write control IC 203 is four (step S1301).

When the number of image-forming colors is four (Yes at step S1301), the write control IC 203 determines whether the number of LDs per color is one (step S1302). When the number of LDs per color is one (Yes at step S1302), “1” is set at the memory 215a, “2” is set at the memory 215c, “3” is set at the memory 215e, and “4” is set at the memory 215g (step S1303).

When the number of LDs per color is not one (No at step S1302), the write control IC 203 determines that the number of LDs per color is two, and sets “1” at the memory 215a, “1” at the memory 215b, “2” at the memory 215c, “2” at the memory 215d, “3” at the memory 215e, “3” at the memory 215f, “4” at the memory 215g, and “4” at the memory 215h (step S1204).

When the number of image-forming colors is not four (No at step S1301), the write control IC 203 further determines whether the number of image-forming colors is two (step S1305).

When the number of image-forming colors is two (Yes at step S1305), the write control IC 203 sets “1” at the memory 215a, “1” at the memory 215b, “1” at the memory 215c, “1” at the memory 215d, “3” at the memory 215e, “3” at the memory 215f, “3” at the memory 215g, and “3” at the memory 215h (step S1306). With these settings, the write control IC 203 controls four LDs per color with two image-forming colors.

When the number of image-forming colors is not two (No at step S1305), the write control IC 203 determines that the number of image-forming colors is one, and sets “1” at the memory 215a, “1” at the memory 215b, “1” at the memory 215c, “1” at the memory 215d, “1” at the memory 215e, “1” at the memory 215f, “1” at the memory 215g, and “1” at the memory 215h (step S1307). With these settings, the write control IC 203 controls eight LDs per color with one image-forming color.

Through the procedure explained above, the switch control register 212 of the write control IC 203 can be updated. With this, the storage destinations of the image data output from the image processing units 213a to 213d can be changed. Here, the procedure explained above is merely an example of the procedure until the switch control register 212 of the write control IC 203 performs updating, and is not meant to restrict the present invention.

In the embodiment, the memories 215a to 215h are separately configured as hardware, and plural memories are provided. However, the configuration of the storage unit of the write control IC is not meant to be restricted to the configuration in which separate memories are provided as hardware. Alternatively, such a configuration may be possible as that a plurality of predetermined addresses associated with LDs as storage destinations are held in one memory, and image data is transmitted to these addresses.

In the first embodiment and its modification examples explained above, the switch control unit 214 is not meant to be restricted to switch the storage destination of the image data according to the image forming apparatus. Alternatively, for example, in image forming apparatuses of the same model, the memories may be switched when the number of image-forming colors is four, two, and then one.

In the write control IC 203, the memories 215a to 215h serving as storage destinations of the image data output from the image processing units 213a to 213d can be switched. With this, write control of various models of image forming apparatuses, irrespectively of monochrome-dedicated machines or color copiers, can be achieved with one type of the write control IC 203. For example, image forming apparatuses with low and middle printing speeds can have mounted thereon one write control IC 203 is mounted, whilst image forming apparatuses with a high printing speed can have mounted thereon a plurality of the write control ICs 203. Thus, with commonality of the write control IC 203, it is possible to increase IC development efficiency and also to reduce loads on development, IC development cost, and production cost.

As for the write control IC 203, for example, when one write control IC 203 is mounted on an image forming apparatus, redundancy is eliminated compared with the conventional write control ICs, thereby facilitating production of the write control ICs 203 and reducing production cost.

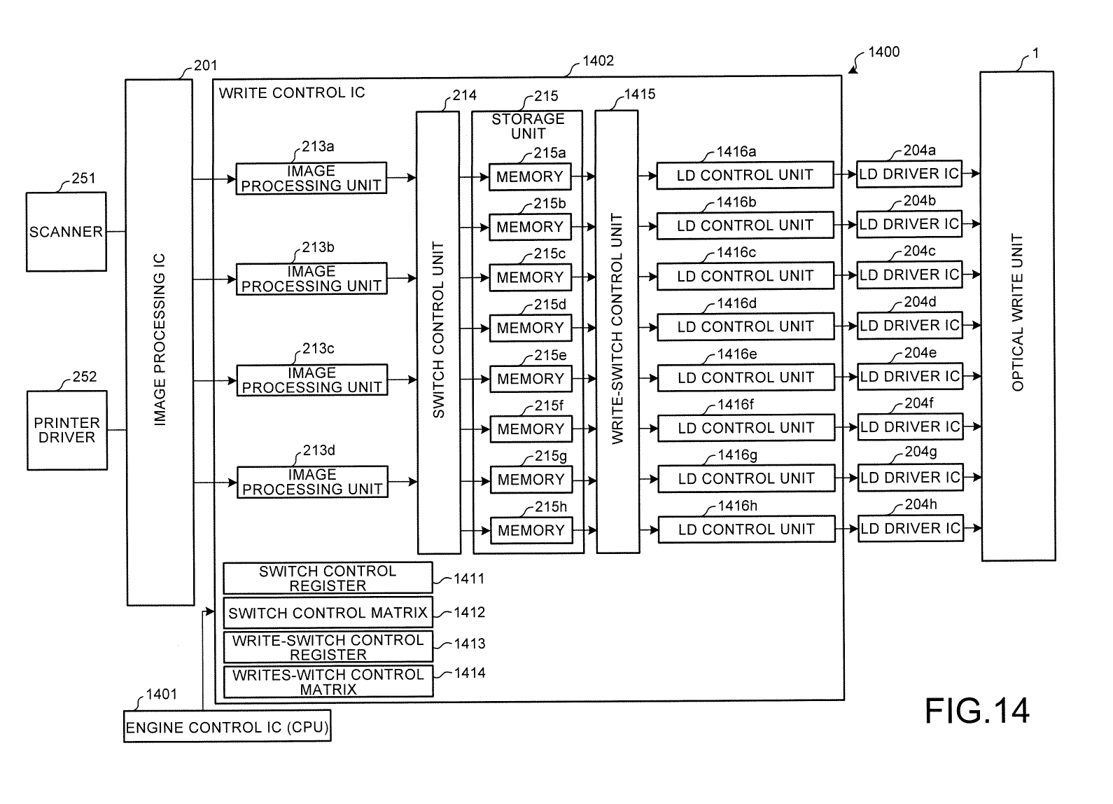

FIG. 14 is a block diagram of an optical writing controller 1400 mounted on an MFP according to a second embodiment of the present invention. The optical writing controller 1400 is different from the optical writing controller 200 in that the engine control IC 202 is replaced by an engine control IC 1401 performing a different process and the write control IC 203 is replaced by a write control IC 1402 performing a different process. In the following explanation, components identical to those in the first embodiment are provided with the same reference numerals, and are not explained.

The engine control IC 1401 is different from the engine control IC 202 in that the engine control IC 1401 outputs information required for updating a switch control register 1411 and a write-switch control register 1413, which are explained further below, to the write control IC 1402. Other than that, the engine control IC 1401 is not different from the engine control IC 202, and is not further explained.

The write control IC 1402 is different from the write control IC 203 according to the first embodiment in that a write-switch control unit 1415 is added, the write-switch control register 1413 and a write-switch control matrix 1414 are added, the LD control units 216a to 216h are replaced by LD control units 1416a to 1416h performing a process from that of the former, and the switch control register 212 and the switch control matrix 211 are replaced by the switch control register 1411 and a switch control matrix 1412 different in configuration from the former.

The switch control matrix 1412 holds a correspondence relation between the image processing units 213a to 213d and LDs for writing, and the memories 215a to 215h serving as storage destinations of the image data processed by the image processing units 213a to 213d. Also, the switch control matrix 1412 is assumed to be stored in a non-rewritable memory (not shown) included in the write control IC 1402, that is, a correspondence storage unit.

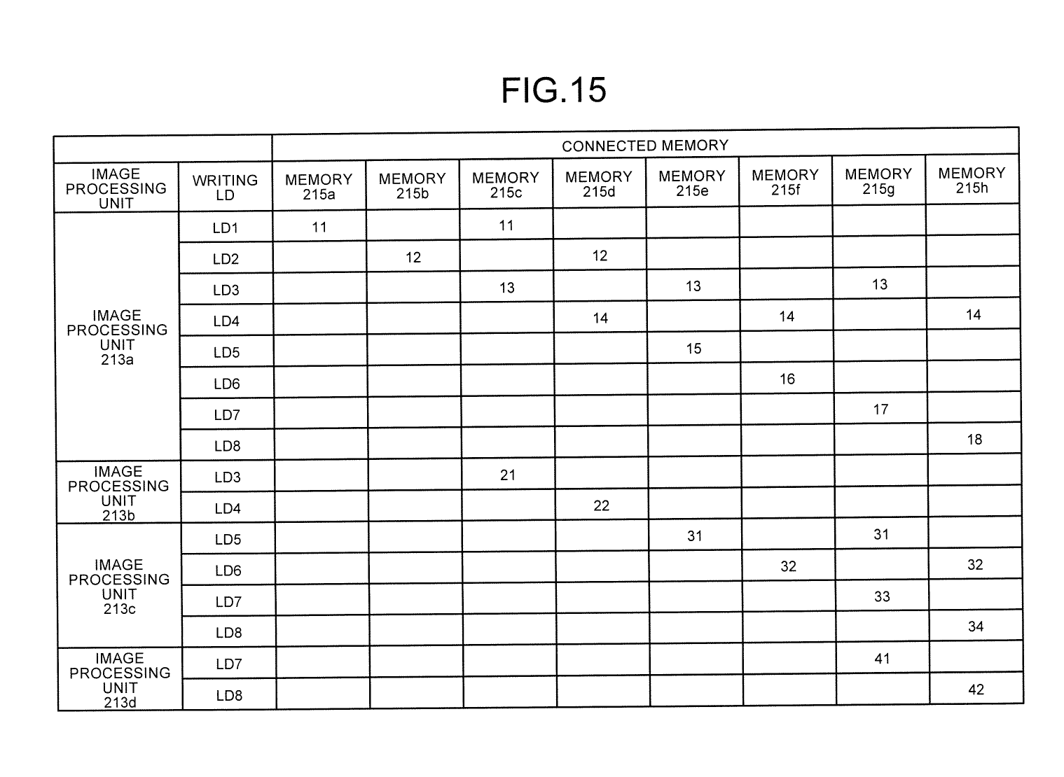

FIG. 15 is an example of a table stored in the switch control matrix 1412. As shown in FIG. 15, the switch control matrix 1412 holds a correspondence relation between the image processing units 213a to 213d and LDs for writing, and the memories 215a to 215h. With this, from the information stored in the switch control matrix 1412, any of the memories 215a to 215h serving as a storage destination can be specified according to the LD for writing the image data processed by the relevant one of the image processing units 213a to 213d. It is assumed herein that LDs 1 to 8 are associated with the LD control units 1416a to 1416h, respectively.

Referring back to FIG. 14, the switch control register 1411 holds values set in the table of the switch control matrix 1412.

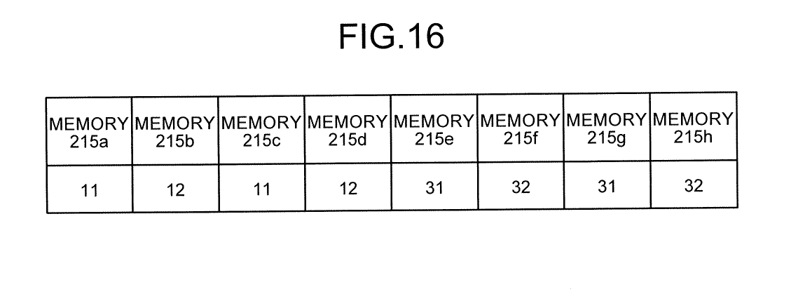

FIG. 16 is an example of a table stored in the switch control register 1411. As shown in FIG. 16, the switch control register 1411 stores therein a two-digit numerical value for each of the memories 215a to 215h. These numerical values are assumed to be those stored in the switch control matrix 1412 shown in FIG. 15. That is, by referring to the switch control matrix 1412 based on the values set in the switch control register 1411, any of the memories 215a to 215h indicative of a storage destination can be specified according to the LD to which the image data processed by the relevant one of the image processing units 213a to 213d is output. Also, the switch control register 1411 is assumed to be stored in a rewritable memory (not shown) included in the write control IC 1402, that is, a specification storage unit.

With the switch control register 1411 and the switch control matrix 1412, any of the memories 215a to 215h serving as a storage destination of the image data processed by the relevant one of the image processing units 213a to 213d is specified according to the writing LD. The reason for this is as follows. That is, in the embodiment, since the memories and the LDs are not associated with one another in advance, it is required to allow the image processing units 213a to 213d to specify a storage destination according to the LD to which the image data is desired to be output.

In the case of the numerical values stored in the switch control register 1411 shown in FIG. 16, the memories 215a and 215c are set with “11”, and are storage destinations of the image data output from the image processing unit 213a to the LD 1. The memories 215b and 215d are set with “12”, and are storage destinations of the image data output from the image processing unit 213a to the LD 2. Furthermore, the memories 215e and 215g are set with “31”, and are storage destinations of the image data output from the image processing unit 213c to the LD 3. Still further, the memories 215f and 215h are set with “32”, and are storage destinations of the image data output from the image processing unit 213c to the LD 4.

Here, the switch control register 1411 updated with the information input from the write control IC 1402 is updated. Specifically, this updating is performed based on the amount of image data and a capacity held by each memory. The write control IC 1402 can determine the number of memories required for storing from the amount of image data included in the input information, and therefore, the switch control register 1411 is updated accordingly. The switch control register 214 performs a switching process based on the updated switch control register 1411.

Referring back to FIG. 14, the write-switch control matrix 1414 holds a correspondence relation between the memories 215a to 215h and the LD control units 1416a to 1416h. Also, the write-switch control matrix 1414 is assumed to be stored in a non-rewritable memory (not shown) included in the write control IC 1402, that is, a write correspondence storage unit.

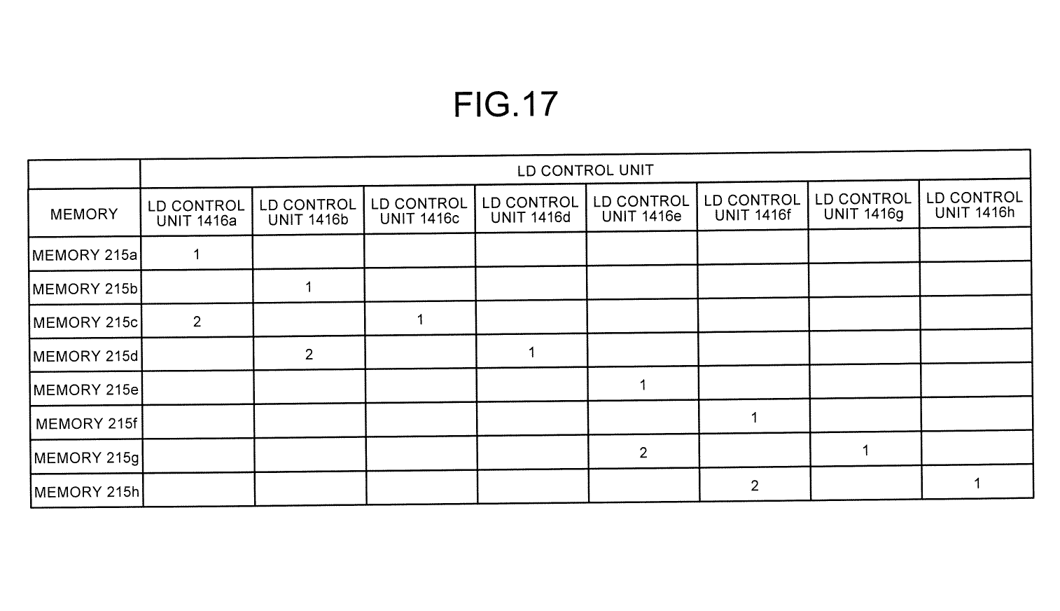

FIG. 17 is an example of a table stored in the write-switch control matrix 1414. As shown in FIG. 17, the write-switch control matrix 1414 holds a correspondence relation between the memories 215a to 215h and the LD control units 1416a to 1416h. In the write-switch control matrix 1414, “1” and “2” can be set to the LD control units 1416a, 1416b, 1416e, and 1416f. If the numerical value indicates “1”, one memory is an obtainment source. If the numerical value indicates “2”, two memories are obtainment sources. For example, if the numerical value of the LD control unit 1416a indicates “1”, the memory 215a is an obtainment source, and if the numerical value indicates “2”, the memories 215a and 215c are obtainment sources.

As shown in FIG. 17, the numerical value settable in the LD control units 1416c, 1416d, 1416g, and 1416h is “1”. That is, the LD control units 1416c, 1416d, 1416g, and 1416h in the embodiment have one obtainment source. Also, the LD control units 1416c, 1416d, 1416g, and 1416h do not have an obtainment source when the LD control units 1416a, 1416b, 1416e, and 1416f obtains from a plurality of locations.

Referring back to FIG. 14, the write-switch control register 1413 holds the values set in the table of the write-switch control matrix 1414.

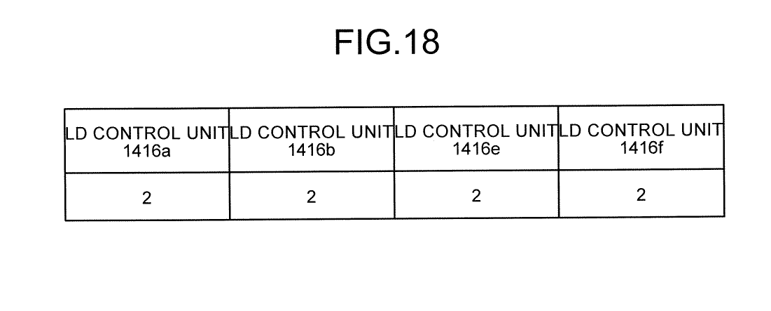

FIG. 18 is an example of a table stored in the write-switch control register 1413. As shown in FIG. 18, the write-switch control register 1413 stores therein a one-digit numerical value foe each of the memories 215a, 215b, 215e, and 215f. These numerical values are assumed to be those stored in the write-switch control matrix 1414. That is, by referring to the write-switch control matrix 1414 based on the values set in the write-switch control register 1413, any of the memories 215a to 215h serving as an obtainment source of the image data of the relevant one of the LD control units 216a to 216h can be specified. Also, the write-switch control register 1413 is assumed to be stored in a rewritable memory (not shown) included in the write control IC 1402, that is, a write specification storage unit.

In the write-switch control register 1413, values cannot be set at the memories 215c, 215d, 215g, and 215h. This is because the obtainment sources of the image data of the LD control units 1416c, 1416d, 1416g, and 1416h are defined according to the memories 215a, 215b, 215e, and 215f, and are not required to be set.

In the example shown in FIG. 18, since “2” is set at the LD control unit 1416a, the memories 215a and the memory 215c are obtainment sources. Also, since “2” is set at the LD control unit 1416b, the memories 215b and the memory 215d are obtainment sources. Furthermore, since “2” is set at the LD control unit 1416e, the memories 215e and the memory 215g are obtainment sources. Still further, since “2” is set at the LD control unit 1416f, the memories 215f and the memory 215h are obtainment sources.

With the write-switch control register 1413 and the write-switch control matrix 1414, any of the memories 215a to 215h serving as an obtainment source of the image data of the relevant one of the LD control units 216a to 216h is specified.

The write-switch control unit 1415 performs switching of obtainment sources to allow the LD control units 216a to 216h to obtain the image data stored in the memories 215a to 215h. Also, the write-switch control unit 1415 can specify any of the memories 215a to 215h serving as an obtainment source of the image data of the relevant one of the LD control units 216a to 216h by referring the write-switch control register 1413 and the write-switch control matrix 1414.

The LD control units 1416a to 1416h obtain image data from any of the memories 215a to 215h that becomes an obtainment source through switching by the write-switch control unit 1415. Here, the LD control units 1416c, 1416d, 1416g and 1416h may not obtain image data, as explained above. As for other processes, the LD control units 1416a to 1416h are similar to the LD control units 216a to 216h, and are therefore not explained herein. Also, when obtaining image data from a plurality of memories, the LD control units 1416a to 1416h performs control so as to unify these pieces of image data into one piece of image data to write the generated image data.

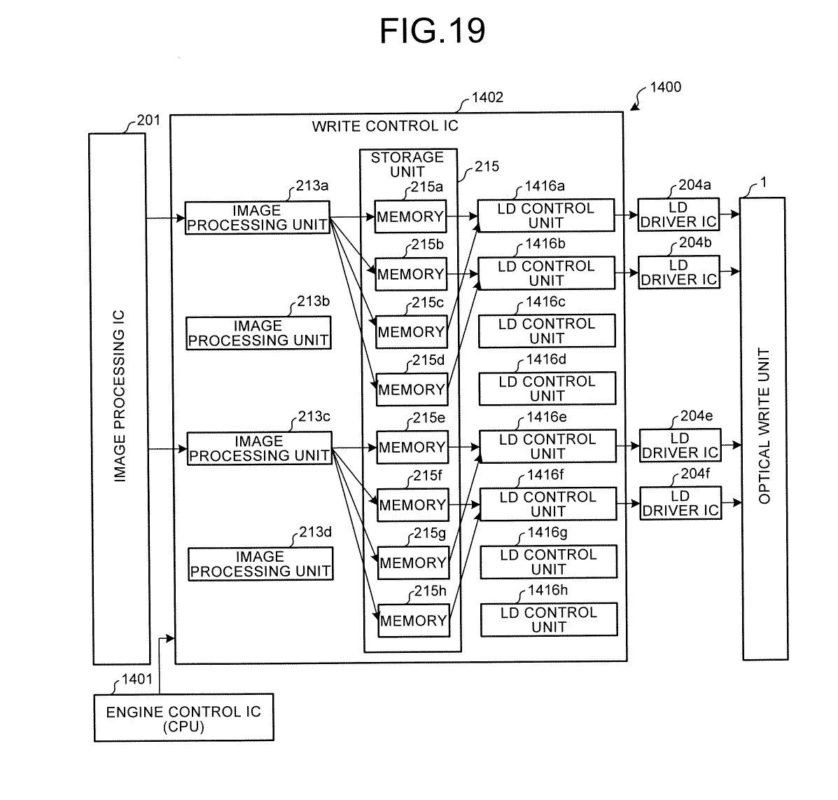

FIG. 19 is a block diagram of the optical writing controller 1400 depicting flow of image data. In the optical writing controller 1400, two LDs are used for each image-forming color and four memories are used. Also, for easy identification of routes of the image data processed by the image processing units 213a to 213d, the switch control unit 214 and the write-switch control unit 1415 are omitted. Similarly, the switch control unit 214 and the write-switch control unit 1415 are omitted in FIG. 19 and onward.

In FIG. 19, the image data from the image processing unit 213a is stored in the memories 215a to 215d. Also, the image data in the memories 215a and 215c is obtained by the LD control unit 1416a. Furthermore the image data in the memories 215b and 215d is obtained by the LD control unit 1416b.

That is, although one LD control unit can obtain image data from only one memory in the first embodiment, the LD control unit can obtain image data from a plurality of memories in the embodiment.

Meanwhile, the amount of information of image data is varied depending on the resolution of the image data handled by the MFP. That is, when image data with high image quality is desired to be output, an image has to be formed based on the image data with a high density, and therefore, the amount of information per LD is increased. That is, the memory capacity required is varied depending on the image quality. If different write control ICs are produced according to the difference in memory capacity, development efficiency is reduced, and production cost is increased. To get around this, it is preferable that image data can be stored with a predetermined memory capacity included in the storage unit 215 of the write control IC 1402 irrespectively of high image quality or low image quality.

Now, consider the case as in the first embodiment that the memories and the LD control units are associated with one another in advance. In this case, the memory capacity for use for each LD is fixed. When the memory capacity of the storage unit 215 is designed so as to allow an output of image data with high image quality, an image forming apparatus for output at low cost with low resolution has a superfluous memory capacity, and production cost is increased. On the other hand, when the memory capacity of the storage unit 215 is designed so that the write control IC 1402 can be mounted on an inexpensive image forming apparatus with low resolution, a sufficient memory capacity cannot be ensured in an image forming apparatus for output with high resolution.

To get around this, in the embodiment, the write-switch control unit 1415 can set a correspondence relation between the LD control units 1416a to 1416h and the memories 215a to 215h, and the number of memories from which image data can be obtained from the LD control unit is changed. With this, the memory capacity for use can be changed according to the image quality of the image data to be output.

That is, in the write control IC 1402, the memories 215a to 215h are designed with the memory capacity suitable for the image forming apparatus for output with low resolution. When the write control IC 1402 is mounted on the image forming apparatus for output with high resolution, the number of memories serving as obtainment sources is changed for each LD control unit, thereby ensuring the memory capacity suitable for high resolution. With this, the write control IC 1402 can reduce production cost, and also can be mounted on plural types of image forming apparatus irrespectively of the output resolution.

As a modification example, a case is explained in which, for outputting monochrome image data, image data is output from the image processing unit 213a to the memories 215a to 215h.

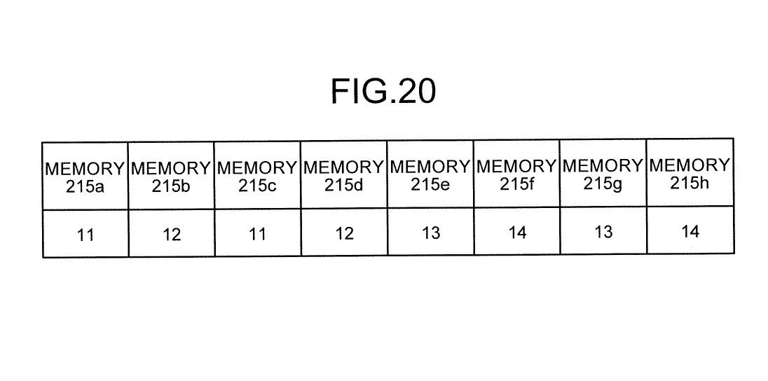

FIG. 20 is an example of a table stored in the switch control register 1411 according to a first modification example of the second embodiment. In the case of numerical values stored in the switch control register 1411 shown in FIG. 20, the memories 215a and 215c are set with “11”, and are storage destinations of the image data to be output from the image processing unit 213a to the LD 1. Also, the memories 215b and 215d are set with “12”, and are storage destinations of the image data to be output from the image processing unit 213a to the LD 2. Furthermore, the memories 215e and 215g are set with “13”, and are storage destinations of the image data to be output from the image processing unit 213a to the LD 3. Still further, the memories 215f and 215h are set with “14”, and are storage destinations of the image data to be output from the image processing unit 213a to the LD 4. That is, image data is output from the image processing units 213a to eight memories 215a to 215h. Here, the values stored in the write-switch control register 1413 are assumed to be identical to those in the example shown in FIG. 18. Next, image data routes in this modification example are explained.

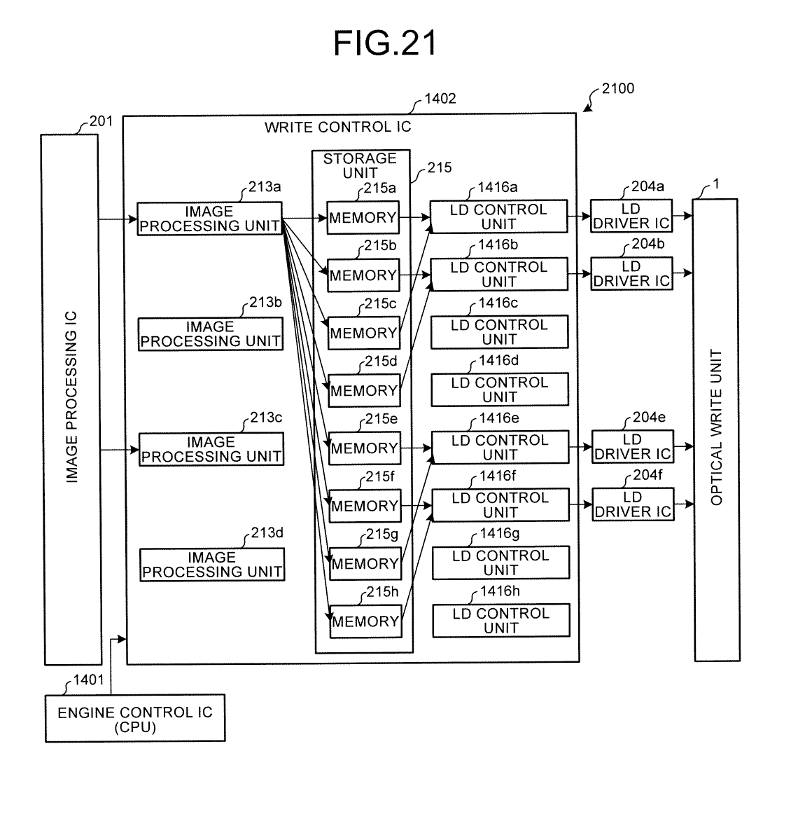

FIG. 21 is a block diagram of an optical writing controller 2100 depicting flow of image data according to the first modification example of the second embodiment. In the optical writing controller 2100 shown in FIG. 21, four LDs are used per image-forming color and eight memories are used.

In FIG. 21, image data from the image processing unit 213a is stored in the memories 215a to 215h. The image data in the memories 215a and 215c are obtained by the LD control unit 1416a. The image data in the memories 215b and 215d are obtained by the LD control unit 1416b. Furthermore, the image data in the memories 215e and 215g are obtained by the LD control unit 1416e. Still further, the image data in the memories 215f and 215h are obtained by the LD control unit 1416f.

In the present modification example, in monochrome printing, two memories are used for each LD control unit, thereby increasing image quality. Also, a printing process is performed with four LDs for each color, thereby increasing the speed.

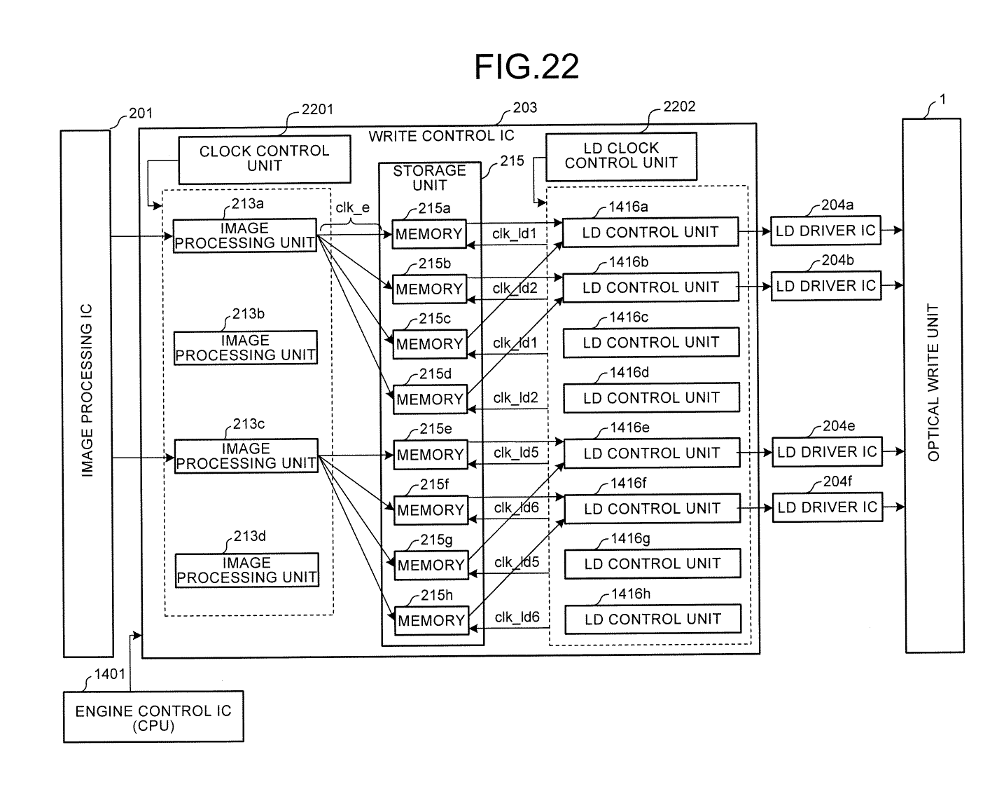

FIG. 22 is a schematic for explaining control of clocks inside the write control IC 1402. As shown in FIG. 22, a clock control unit 2201 controls operation clocks of the image processing units 213a to 213d, whilst an LD clock control unit 2202 controls operation clocks of the LD control units 1416a to 1416h.

The clock control unit 2201 controls the image processing units 213a to 213d with a same clock signal clk_e.

The LD clock control unit 2202 controls the LD control units 216a to 216h with clock signals clk_ld1 to clk_ld8, respectively, in synchronization with a synchronization detection signal of each LD. Also, the LD control units 216a, 216b, 216e, and 216f obtain image data, whilst the LD control units 216c, 216d, 216g, and 216h do not obtain image data.

That is, the LD control unit 216a obtains image data according to the clock signal clk_ld1 from the memories 215a and 215c. Also, the LD control unit 216b obtains image data according to the clock signal clk_ld2 from the memories 215b and 215d. Furthermore, the LD control unit 216e obtains image data according to the clock signal clk_ld5 from the memories 215e and 215g. Still further, the LD control unit 216f obtains image data according to the clock signal clk_ld6 from the memories 215f and 215h.

In this manner, the LD control units 216a, 216b, 216e, and 216f obtain image data because image data is required to be obtained in synchronization with the synchronizing detection signal of each LD. That is, since the LDs and the LD control units are associated with one another, the memories 215a to 215h switches a read control clock for reading image data according to the LD control unit that obtains image data.

As shown in FIG. 22, unlike the case where the memories 215a and 215b are obtainment sources of the image data of the LD control unit 1416a and the memories 215c and 215d are obtainment sources of the image data of the LD control unit 1416b in which the memories are in ascending order, the memories 215a and 215c are obtainment sources of the image data of the LD control unit 1416a and the memories 215b and 215d are obtainment sources of the image data of the LD control unit 1416b.

This is due to timing management with control clocks. That is, if one memory is provided with a plurality of clocks, management has to be performed in consideration of a wiring delay of a clock signal, for example. If the LD control units and the memories are connected in ascending order, it is required that only clk_ld1 be for the memory 215a, clk_ld2 and clk_ld1 can be switched for the memory 215b, clk_ld3 and clk_ld2 can be switched for the memory 215c, and clk_ld4 and clk_ld2 can be switched for the memory 215d. By contrast, in the embodiment, it is required that only clk_ld1 be for the memory 215a, only clk_ld2 be for the memory 215b, clk_ld3 and clk_ld1 can be switched for the memory 215c, and clk_ld4 and clk_ld2 can be switched for the memory 215d. That is, in the write control IC 1402, with only the clock signal clk_ld2 for the memory 215b, timing management conditions for clock signals are reduced compared with the case of the ascending order, thereby achieving management with ease.

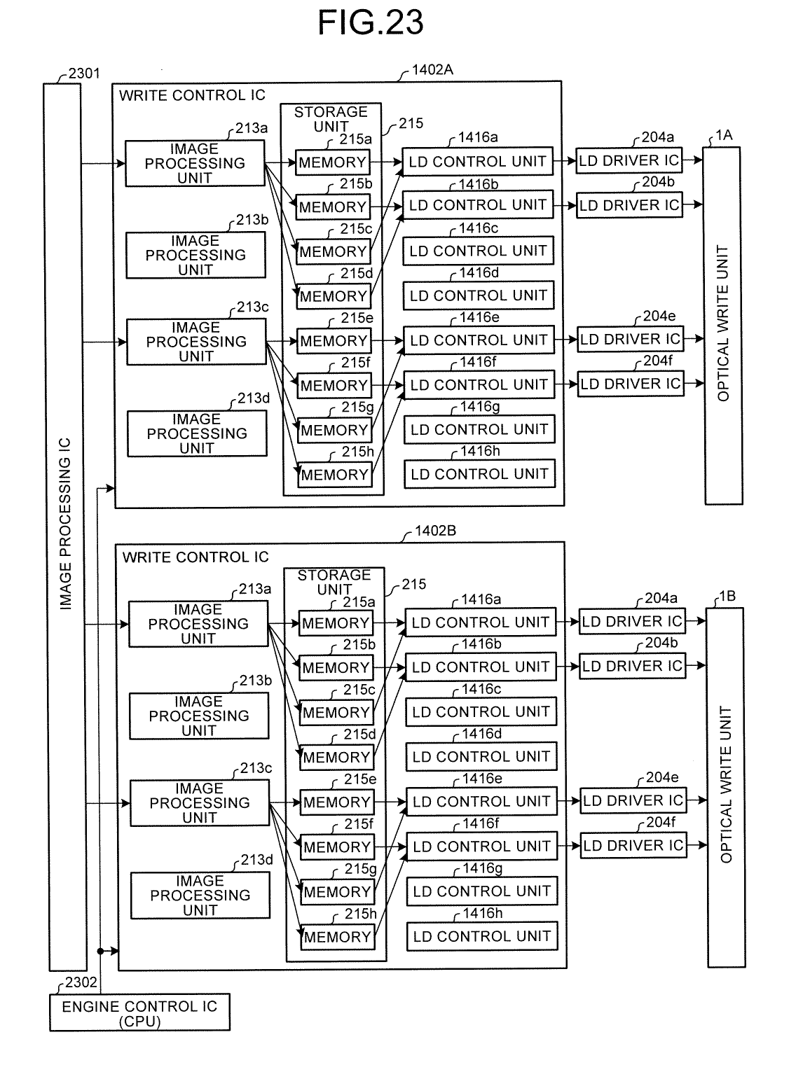

FIG. 23 is a block diagram of an optical writing controller including two write control ICs 1402A and 1402B applied to a color image forming apparatus according to a second modification example of the second embodiment. The write control ICs 1402A and 1402B are mounted on a color image forming apparatus. With this, in the case of four image-forming colors, the number of LDs driven-controlled per color is two. Also, with one LD control unit, image data can be obtained from two memories.

An image processing IC 2301 outputs different image data signals of two colors to the write control IC 1402A and the write control IC 1402B. An engine control IC 2302 outputs information required for updating the switch control register 1411 and the write-switch control register 1413 to the write control IC 1402A and the write control IC 1402B.

As shown in FIG. 23, when the number of LDs per color is two, there may be the case where, for printing with high image quality, the memory capacity of two memories are required for one LD control unit. Thus, in the present modification example, two write control IC 1402 are mounted on the image forming apparatus.

With this, the number of LDs per unit is two, and also the memory capacity of two memories can be ensured for one LD control unit, thereby allowing printing with high image quality.

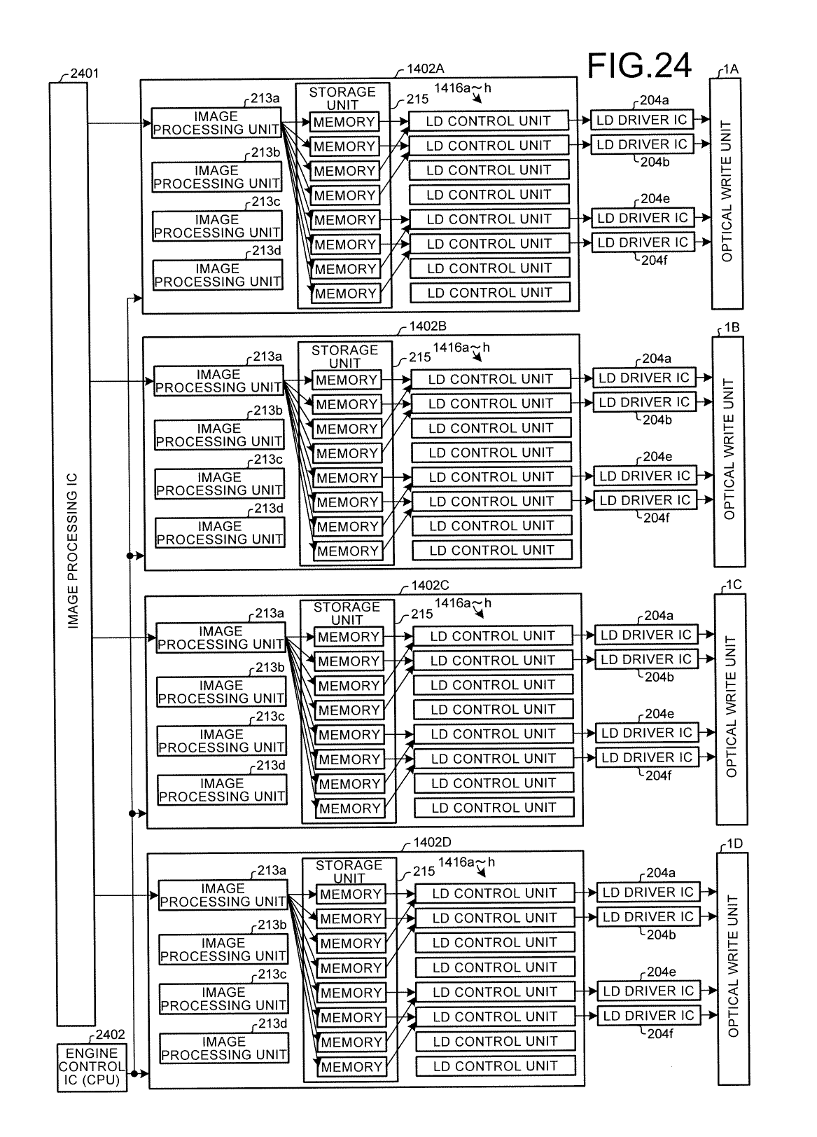

FIG. 24 is a block diagram of an optical writing controller including four write control ICs 1402A to 1402D applied to a color image forming apparatus according to a third modification example of the second embodiment. It is assumed that the four write control ICs 1402A, 1402B, 1403C, and 1403D are mounted on the color image forming apparatus, the number of image-forming colors is four, and the number of LDs that can driven-controlled per color is four. Also, an image processing IC 2401 outputs different image data signals of one color to the write control ICs 1402A, 1402B, 1403C, and 1403D. Also, an engine control IC 2402 outputs information required for updating the switch control register 1411 and the write-switch control register 1413 to the write control ICs 1402A, 1402B, 1403C, and 1403D.

As shown in FIG. 24, the number of LDs driven per color is four. With this, the image forming apparatus according to the third modification example achieves a further increase in speed. Also, since the memory capacity of two memories is ensured for one LD control unit, printing can be made with high image quality.

The modification example shown in FIG. 24 is similar to the configuration of the conventional technology in that one write control IC 1402 is mounted per color. Only the image processing unit 213a is used and the other image processing units 213b to 213d are not used, and therefore, the configuration seems redundant. However, since the common write control IC 1402 among a plurality of models can be mounted, cost can be reduced due to commonality.

Here, in the embodiment, the case has been explained in which one LD control unit obtains image data from two memories. Alternatively, the LD control unit may obtain image data from more memories according to the amount of information of the image data. With this, the image quality can be further increased.

In the embodiments explained above, eight LD controllers are provided for each write control IC. However, this embodiment does not restrict the number of LD control units included in the write control IC. In another modification example, as an example in which the number of LD control units is small, it is assumed that four LD control units are provided for a write control IC.

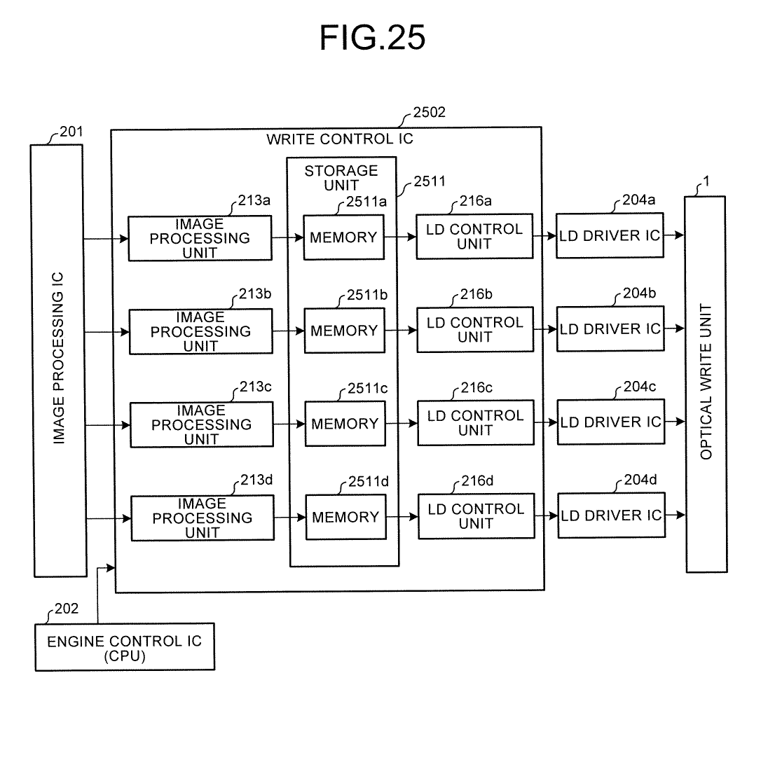

FIG. 25 is a block diagram of an optical writing controller 2500 according to another embodiment. A write control IC 2502 of the optical writing controller 2500 includes a storage unit 2511 having four memories 2511a to 2511d and four LD control units 216a to 216d. Although not shown in FIG. 25, the write control IC 2502 also includes the switch control unit 214. The write control IC 2502 can control four LDs at maximum and can process image data up to four colors of image-forming color.

That is, in the case where the write control IC of the modification example includes one LD control unit, one image-forming color is written with one LD, and it is assumed that the write control IC is applied to a low-speed printer. The number of image processing units included in the write control IC can be eight or more. The write control IC can include any number of LD control units.

As set forth hereinabove, according to an embodiment of the present invention, one write-control integrated circuit includes a plurality of image processing units and a plurality of write control units. The write control units can be switched to control writing of input image data processed by the image processing units. Thus, the write-control integrated circuit can be mounted on a plurality of types of image forming apparatuses, which reduces development loads occurring due to separate development for each model.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical writing controller comprising:
a storage unit that includes a plurality of storage areas to store image data;
a plurality of image processing units that process the image data;
a switch control unit that switches the storage areas to store image data processed by each of the image processing units; and
a plurality of write control units that control a writing unit that writes to a recording medium the image data stored in each of the storage areas to form an image.

2. The optical writing controller according to claim 1, further comprising:
a first storage unit that stores therein association information on an association between the image processing units and the storage areas that are available to store image data processed by the image processing units; and
a second storage unit that stores therein, based on the association information, specifying information that specifies at least one of the storage areas to store image data processed by each of the image processing units, wherein
the switch control unit switches the storage areas to store the processed image data based on the specifying information.

3. The optical writing controller according to claim 1, further comprising a write-switch control unit that switches the storage areas from which the write control units obtain the image data to be written by the writing unit for each of the write control units.

4. The optical writing controller according to claim 3, further comprising:
a first storage unit that stores therein association information on an association between the write control units and the storage areas that are available for the write control units to obtain the image data to be written; and
a second storage unit that stores therein, based on the association information, specifying information that specifies at least one of the storage areas from which each of the write control units obtains image data to be written, wherein
the write-switch control unit switches the storage areas from which the write control units obtain the image data to be written based on the specifying information.

5. The optical writing controller according to claim 1, wherein
the image processing units each correspond to a color, and
the image processing units each have a predetermined function of processing image data of the color.

6. The optical writing controller according to claim 2, wherein the association information indicates a predetermined number of storage areas associated with each of the image processing units according to color of image data corresponding to each of the image processing units.

7. The optical writing controller according to claim 2, wherein the association information indicates that, among the image processing units, an image processing unit that processes image data of a predetermined color is associated with all the storage areas.

8. The optical writing controller according to claim 7, wherein the image processing unit that processes image data of the predetermined color has a function of processing at least image data of black color.

9. The optical writing controller according to claim 7, wherein the image processing unit that processes image data of the predetermined color has functions of processing image data of a plurality of colors used in the image.

10. The optical writing controller according to claim 1, wherein the switch control unit switches the storage areas such that image data processed by a predetermined one of the image processing units is stored in one half of the storage areas.

11. The optical writing controller according to claim 1, wherein the switch control unit switches the storage areas such that image data processed by a predetermined one of the image processing units is stored in one quarter of the storage areas.

12. The optical writing controller according to claim 3, wherein the write-switch control unit switches the storage areas such that each of the write control units obtains image data to be written from one of the storage areas.

13. The optical writing controller according to claim 3, wherein the write-switch control unit switches the storage areas such that each of the write control units obtains image data to be written from a plurality of storage areas.

14. The optical writing controller according to claim 3, wherein the switch control unit switches the storage areas according to number of storage areas required to store the image data derived from an amount of the image data processed by each of the image processing units and a capacity of the storage areas.

15. The optical writing controller according to claim 3, wherein the write-switch control unit switches the storage areas in such a manner as to allow each of the write control units to obtain image data from a plurality of storage areas and combine the image data into a set.

16. The optical writing controller according to claim 1, wherein the write control units read the image data from the storage unit based on a clock signal for each of the write control units.

17. An image forming apparatus comprising:
optical writing controller that includes
a storage unit that includes a plurality of storage areas to store image data;
a plurality of image processing units that process the image data;
a switch control unit that switches the storage areas to store image data processed by each of the image processing units; and
a plurality of write control units that control writing of the image data stored in each of the storage areas to a recording medium; and
a writing unit that writes the image data to the recording medium under control of the write control units.
